(19) United States
(12) Patent Application Publication
(10) Pub. No.: US 2016/0377714 A1
(43) Pub. Date: Dec. 29, 2016

(54) SIGNAL PROCESSING DEVICE

(71) Applicant: Panasonic Intellectual Property Management Co., Ltd., Osaka-shi, Osaka (JP)

(72) Inventor: Tatsuo MASUDA, Osaka (JP)

(21) Appl. No.: 15/039,877

(22) PCT Filed: Nov. 27, 2014
(86) PCT No.: PCT/JP2014/005930

§ 371 Date: May 27, 2016

(30) Foreign Application Priority Data
Dec. 3, 2013 (JP) 2013-250383

(51) Int. Cl. G01S 13/56; G01S 7/292

(52) U.S. Cl. CPC G01S 13/56; G01S 7/2922

(57) ABSTRACT

The signal processing device processes a sensor signal from a radio wave sensor. The parameter adjuster changes a parameter for adjusting detection sensitivity of an object for a recognition process. The parameter adjuster sets the parameter to increase the detection sensitivity of the object when the sensitivity level set by the level setter is a high level, and sets the parameter to decrease the detection sensitivity of the object when the sensitivity level set by the level setter is a low level.

### TECHNICAL FIELD

The present invention relates generally to signal processing devices, and particularly to a signal processing device for performing signal processing on sensor signals from a sensor for receiving wireless signals reflected by an object.

### BACKGROUND ART

In the past, there has been proposed a lighting system with a configuration shown in FIG. 36 (see JP 2011-47779 A referred to as “Document 1” hereinafter). This lighting system includes: an object detection device 101 including a sensor 110 configured to identify presence or absence of an intended object of detection in a detection area and output a sensor signal; and a lighting fixture 102 whose lighting state is controlled by the object detection device 101.

The sensor 110 is a millimeter wave sensor configured to send a millimeter wave to the detection area and receive a millimeter wave reflected by the intended object of detection moving in the detection area and output a sensor signal with a Doppler frequency corresponding to a difference between frequencies of the sent millimeter wave and the received millimeter wave.

The object detection device 101 includes an amplifier circuit 111 configured to divide the sensor signal outputted from the sensor 110 into signals of frequency bands and amplify the components of frequency bands, and a judging unit 112 configured to compare an output of the amplifier circuit 111 with a predetermined threshold to determine whether the intended object of detection is present. Further, the object detection device 101 includes a lighting control unit 113 configured to control the lighting state of the lighting fixture 102 according to the determination result of the judging unit 112.

Further, the object detection device 101 includes a frequency analyzing unit 114 configured to measure intensities of signals of individual frequencies of the sensor signal outputted from the sensor 110. Further, the object detection device 101 includes a noise remover (a noise judging unit 115 and a switching circuit 116) configured to reduce, by use of the analysis result of the frequency analyzing unit 114, effects of noise of a particular frequency which is present constantly. In this regard, the frequency analyzing unit 114 may include an FFT (fast Fourier transform) analyzer. The judging unit 112, the lighting control unit 113, and the noise remover are included in a control block 117 mainly composed of a microcomputer. The amplifier circuit 111 constitutes a signal processor configured to output signals of individual predetermined frequency bands of the sensor signal. Note that, document 1 discloses that the signal processor may be constituted by an FFT analyzer, a digital filter, and the like.

The amplifier circuit 111 includes a plurality of amplifiers 118 including operational amplifiers, and thus frequency bands for amplifying signals by the amplifiers 118 can be set by adjusting various types of parameters of circuits constituting each amplifier 118. In short, each of the amplifiers 118 functions as a bandpass filter allowing passage of a signal with a particular frequency band. Consequently, the amplifier circuit 111 divides the sensor signal into signals of a plurality of frequency bands by the plurality of amplifiers 118 connected in parallel, and amplifies the signals of frequency bands by the amplifiers 118 and outputs the resultant signals individually.

The judging unit 112 includes comparators 119 individually corresponding to the amplifiers 118. Each comparator 119 performs A/D conversion of an output of the corresponding amplifier 118 into a digital value and compares the resultant digital value with a predetermined threshold. Thereby the judging unit 112 identifies presence or absence of the intended object of detection. The thresholds of the comparators 119 are individually set according to the corresponding pass bands (i.e., the corresponding amplifiers 118). When the output of the amplifier 118 is out of a range determined by the threshold, the comparator 119 outputs an H level signal. The threshold Vth of the individual pass bands set in the initial state (shipping state) is represented by Vth=Vavg±Vppᵢₙᵢ. Vppᵢₙᵢ denotes a maximum of a peak-to-peak Vpp of an output value V of the amplifier 118 which is measured in a constant period under a condition where there is no reflection of electromagnetic waves (such as inside a radio wave dark room). Vavg denotes an average of the output value V.

Further, the judging unit 112 includes a logical disjunction circuit 120 configured to calculate logical disjunction of comparison results. When the signals include at least one high level (H level) signal, the logical disjunction circuit 120 outputs a detection signal indicative of “detection state” which means that the object of detection target is present. In contrast, when all of the signals are low level (L level) signals, the logical disjunction circuit 120 outputs a detection signal indicative of “non-detection state” which means that the object of detection target is not present. The detection signal shows “1” when being in the detection state, and shows “0” when being in the non-detection state.

The noise remover includes the noise judging unit 115 configured to determine whether noise of a particular frequency which is present constantly is present, based on the output from the frequency analyzing unit 114, and the switching circuit 116 configured to switch output states of the amplifiers 118 with regard to the judging unit 112 according to the determination result of the noise judging unit 115.

The switching circuit 116 includes switches 121 individually interposed between the amplifiers 118 of the amplifier circuit 111 and the comparators 119 of the judging unit 112. In the initial state, all of the switches 121 are turned on. By individually turning on or off the switches 121 by outputs from the noise judging unit 115, outputs from the amplifiers 118 to the judging unit 112 are individually set to valid or invalid. In short, in the switching circuit 116, by turning off the switch 121 corresponding to the amplifier 118 associated with a desired pass band by the output from the noise judging unit 115, it is possible to invalidate the output of the amplifier 118 of interest.

The noise judging unit 115 reads in the signal intensities (voltage intensities) of frequencies (frequency components) of the sensor signal outputted from the frequency analyzing unit 114 and store them in a memory (not shown), and determines whether noise with a particular frequency which is present constantly is present by use of the stored data.

When the noise judging unit 115 determines that noise with the particular frequency is present constantly, the noise judging unit 115 controls the switching circuit 116 so as to turn off the switch 121 between the judging unit 112 and the amplifier 118 associated with the pass band including the frequency of the noise. Consequently, when the noise with the particular frequency is present constantly, the output of the amplifier circuit 111 to the judging unit 112 is invalidated with regard to the frequency band including the frequency of the noise. The on or off state of the switch 121 is updated each time the noise judging unit 115 determines “normal state”.

In the object detection device 101 disclosed in document 1, it is considered that components other than the sensor 110 and the lighting control unit 113 constitute a signal processing device configured to perform signal processing on the sensor signal of the sensor 110 constituted by a millimeter sensor. However, when the object detection device 101 is used in outdoors for example, due to motion of an object other than a detection target (intended object of detection), false detection in which an unintended object of detection is misidentified as the intended object of detection may occur. Further, there is a demand to ensure detection sensitivity of the intended object of detection.

Note that, motion of an object other than a detection target may include raining, motion of sway of branches and leaves of trees, and motion of sway of electric wires, for example.

### SUMMARY OF INVENTION

In view of the above insufficiency, an objective of the present invention would be to propose a signal processing device capable of reducing a probability of false detection caused by motion of an object other than an intended object of detection while balancing improvement of the detection sensitivity with reduction of the probability of the false detection.

A signal processing device of one aspect according to the present invention includes: a frequency analyzer configured to convert a sensor signal which is outputted from a sensor for receiving a wireless signal reflected by an object and depends on motion of the object, into a frequency domain signal, and extract, by use of a group of individual filter banks with different frequency bands, signals of the individual filter banks from the frequency domain signal; a recognizer configured to perform a recognition process of detecting the object based on at least one of a frequency distribution based on the signals of the individual filter banks and a component ratio of signal intensities based on the signals of the individual filter banks; a level setter configured to set a sensitivity level indicative of whether detection sensitivity of the object for the recognition process is high or low; and a parameter adjuster configured to change a parameter for adjusting the detection sensitivity of the object for the recognition process. The parameter adjuster is configured to set the parameter to increase the detection sensitivity of the object when the sensitivity level set by the level setter is high, and being configured to set the parameter to decrease the detection sensitivity of the object when the sensitivity level set by the level setter is low.

The signal processing device of one aspect according to the present invention can offer effects of reducing a probability of false detection caused by motion of an object other than an intended object of detection while balancing improvement of the detection sensitivity with reduction of the probability of the false detection.

### BRIEF DESCRIPTION OF DRAWINGS

FIG. 1 is a block diagram illustrating a sensor device including a radio wave sensor and a signal processing device according to one embodiment.

FIGS. 2A to 2C are explanatory views illustrating a normalizer of the signal processing device of the embodiment.

FIGS. 3A to 3C are explanatory views illustrating a smoothing processor used in the signal processing device of the embodiment.

FIGS. 4A to 4C are explanatory views illustrating an example of a background signal remover of the signal processing device according to the embodiment.

FIG. 5 is an explanatory view illustrating another example of the background signal remover of the signal processing device according to the embodiment.

FIGS. 6A and 6B are explanatory views illustrating another example of the background signal remover of the signal processing device according to the embodiment.

FIG. 7 is a block diagram illustrating an adaptive filter constituting another example of the background signal remover of the signal processing device according to the embodiment.

FIGS. 8A to 8C are explanatory views illustrating a recognition process based on principle component analysis of the signal processing device according to the embodiment.

FIGS. 9A and 9B are explanatory views illustrating a usage example of the sensor device according to the embodiment.

FIG. 10 is a waveform chart illustrating a sensor signal from the radio wave sensor of the sensor device according to the embodiment.

FIG. 11 is an explanatory view illustrating output of the normalizer of the signal processing device according to the embodiment.

FIG. 12 is a waveform chart illustrating an output signal of the signal processing device according to the embodiment.

FIG. 13 is an explanatory view illustrating a usage example of the sensor device including the radio wave sensor, and the signal processing device, according to the embodiment.

FIG. 14 is a waveform chart illustrating the sensor signal of the radio wave sensor of the sensor device according to the embodiment.

FIG. 15 is a waveform chart illustrating the output signal of the signal processing device according to the embodiment.

FIG. 16 is an explanatory view illustrating output of the normalizer of the signal processing device according to the embodiment.

FIG. 17 is a waveform chart illustrating the output signal of the signal processing device according to the embodiment.

FIG. 18 is an explanatory view illustrating a recognition process based on multiple linear regression analysis of the signal processing device according to the embodiment.

FIGS. 19A and 19B are other explanatory views illustrating the recognition process based on multiple linear regression analysis of the signal processing device according to the embodiment.

FIG. 20 is an explanatory view illustrating majority decision by a recognizer of the signal processing device according to the embodiment.

FIGS. 21A and 21B are explanatory views illustrating the signal processing device according to the embodiment.

FIG. 22 is an explanatory view illustrating a group of filter banks according to the embodiment.

FIG. 23 is a flow chart of operation according to the embodiment.

FIG. 24 is a waveform chart of the sensor signal from the radio wave sensor of the sensor device according to the embodiment.

FIG. 25 is a waveform chart of the sensor signal from the radio wave sensor of the sensor device according to the embodiment.

FIG. 26 is a waveform chart illustrating the output signal of the signal processing device according to the embodiment.

FIG. 27 is a waveform chart illustrating the output signal of the signal processing device according to the embodiment.

FIG. 28 is a waveform chart illustrating the output signal of the signal processing device according to the embodiment.

FIG. 29 is a waveform chart illustrating the output signal of the signal processing device according to the embodiment.

FIG. 30 is an explanatory view illustrating operation of a state machine of the signal processing device according to the embodiment.

FIG. 31 is an explanatory view illustrating operation of the state machine of the signal processing device according to the embodiment.

FIG. 32 is a waveform chart of the sensor signal from the radio wave sensor of the sensor device according to the embodiment.

FIG. 33 is a waveform chart illustrating the output signal of the signal processing device according to the embodiment.

FIG. 34 is a state diagram of a flag according to the embodiment.

FIG. 35 is a waveform chart illustrating the output signal of the signal processing device according to the embodiment.

FIG. 36 is a block diagram illustrating a configuration of a conventional lighting system.

### DESCRIPTION OF EMBODIMENTS

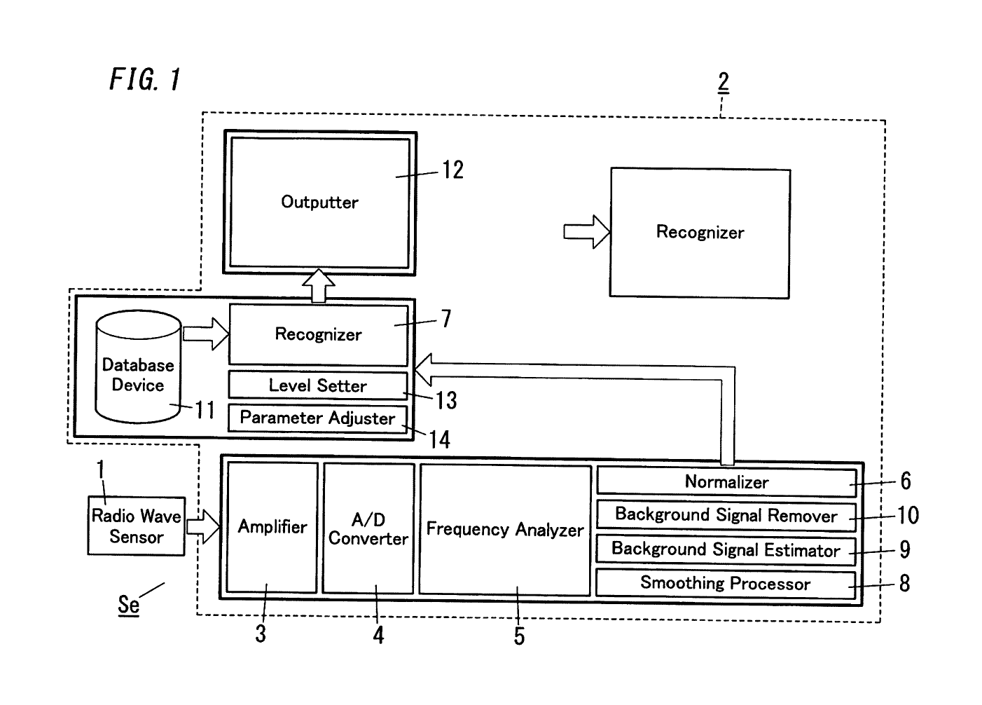

Hereinafter, a signal processing device of the present embodiment is described with reference to FIG. 1 to FIG. 35.

The signal processing device 2 is configured to perform signal processing on a sensor signal outputted from a radio wave sensor 1. Note that, FIG. 1 is a block diagram illustrating a sensor device Se including the radio wave sensor 1 and the signal processing device 2.

The radio wave sensor 1 may be a Doppler sensor. The Doppler sensor sends a radio wave with a predetermined frequency to a detection area, and receives a radio wave reflected by an object moving in the detection area, and outputs a sensor signal with a Doppler frequency corresponding to a difference between frequencies of the sent radio wave and the received radio wave. Therefore, a sensor signal is an analog time axis signal depending on motion of the object.

The radio wave sensor 1 includes a transmitter for sending a radio wave to the detection area, a receiver for receiving a radio wave reflected by the object in the detection area, and a mixer for outputting a sensor signal with a frequency corresponding to a difference between frequencies of the sent radio wave and the received radio wave. The transmitter includes an antenna for transmission. Further, the receiver includes an antenna for reception. Note that, a radio wave sent from the transmitter may be a millimeter wave with the predetermined frequency of 24.15 GHz, for example. The radio wave sent from the transmitter is not limited to a millimeter wave and may be a micro wave. Further, this value is one example of the predetermined frequency of the radio wave to be sent, and there is no intent to limit the predetermined frequency to this value. When the object reflecting the radio wave is moving in the detection area, a frequency of a reflection wave is shifted by the Doppler effect.

The signal processing device 2 includes an amplifier 3 configured to amplify the sensor signal, and an A/D converter 4 configured to convert the sensor signal amplified by the amplifier 3 into a digital sensor signal and output the digital sensor signal. The amplifier 3 may include an amplifier including an operational amplifier, for example.

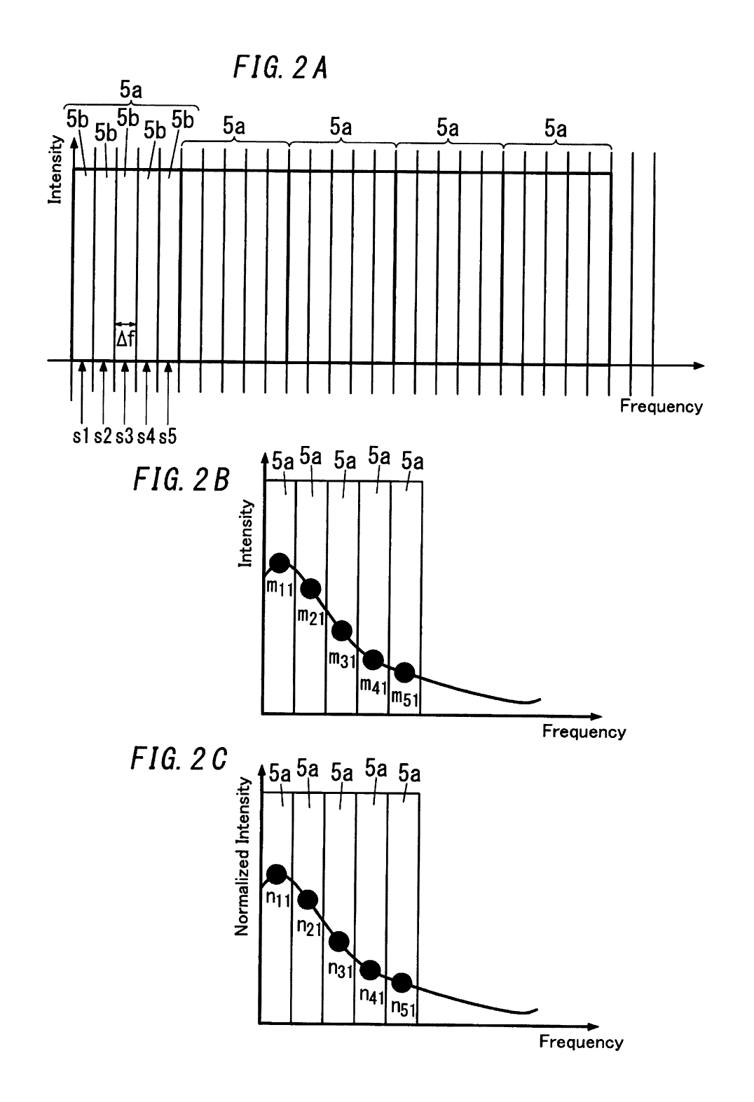

Additionally, the signal processing device 2 includes a frequency analyzer 5. The frequency analyzer 5 is configured to convert a time domain sensor signal outputted from the A/D converter 4 into a frequency domain signal (frequency axis signal) and extract, by use of a group of individual filter banks 5a (see FIG. 2A) with different frequency bands, signals of the individual filter banks 5a from the frequency domain signal.

In the frequency analyzer 5, a predetermined number of (for example, sixteen) filter banks 5a is set as a group of filter banks 5a. However, this number is one example, and there is no intent to limit the number of filter banks 5a in one group to this number.

Further, the signal processing device 2 includes a normalizer 6. The normalizer 6 is configured to normalize intensities of the signals individually passing through the individual filter banks 5a by a sum of intensities of the signals extracted by the frequency analyzer 5 or a sum of intensities of signals individually passing through a plurality of predetermined filter banks 5a (for example, four filter banks on a lower frequency side) selected from the individual filter banks 5a to obtain normalized intensities, and output the normalized intensities.

Further, the signal processing device 2 includes a recognizer 7 configured to perform a recognition process of detecting the object based on a frequency distribution calculated from the normalized intensities of the individual filter banks 5a outputted from the normalizer 6.

The aforementioned frequency analyzer 5 has a function of converting the time domain sensor signal outputted from the A/D converter 4 into the frequency domain signal by Discrete Cosine Transform (DCT). Further, as shown in FIG. 2A, each of the individual filter banks 5a includes a plurality of (in the illustrated example, five) frequency bins 5b. The frequency bin 5b of the filter bank 5a using DCT may be referred to as a DCT bin, in some cases. Each of the filter banks 5a has resolution depending on widths (Δf in FIG. 2A) of the frequency bins 5b. With regard to each of the filter banks 5a, this number is one example of the number of frequency bins 5b, and there is no intent to limit the number of frequency bins 5b to this number. The number of frequency bins 5b may be two or more other than five or may be one. Orthogonal transform for converting the sensor signal outputted from the A/D converter 4 into the frequency domain signal is not limited to DCT, and, for example may be Fast Fourier Transformation (FFT). The frequency bin 5b of the filter bank 5a using FFT may be referred to as an FFT bin, in some cases. Further, the orthogonal transform for converting the sensor signal outputted from the A/D converter 4 into the frequency domain signal may be Wavelet Transform (WT).

When each of the filter banks 5a includes a plurality of frequency bins 5b, it is preferable that the signal processing device 2 include a smoothing processor 8 between the frequency analyzer 5 and the normalizer 6. It is preferable that this smoothing processor 8 have at least one of two smoothing processing functions described below. The first one of the smoothing processing functions is a function of performing smoothing processing on intensities of signals of the individual frequency bins 5b in a frequency domain (frequency axis direction) for each of the individual filter banks 5a. The second one of the smoothing processing functions is a function of performing smoothing processing on intensities of signals of the individual frequency bins 5b in a time axis direction for each of the individual filter banks 5a. Accordingly, the signal processing device 2 can reduce undesired effects caused by noises, and more reduce the undesired effects caused by noises when the both functions are included.

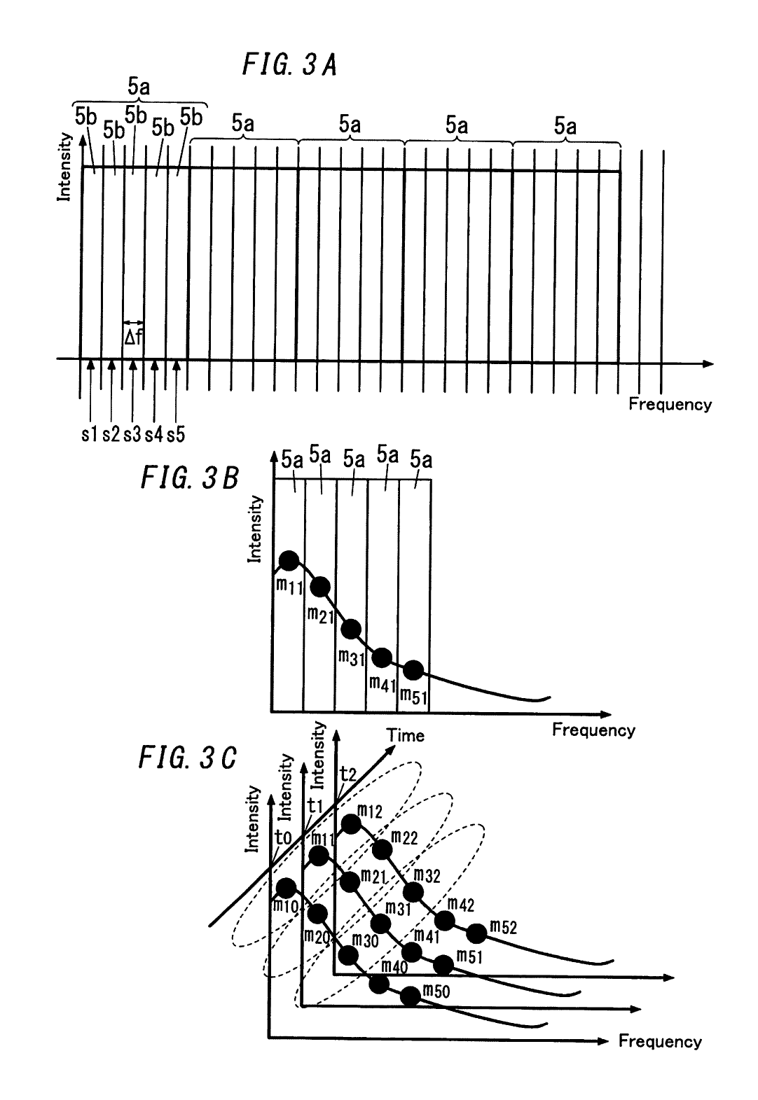

The function of performing smoothing processing on intensities of signals of the individual frequency bins 5b in the frequency domain for each of the individual filter banks 5a is referred to as a first smoothing processing function. The first smoothing processing function can be realized by use of, for example, an average filter, a weighted average filter, a median filter, a weighted median filter, or the like. When the first smoothing processing function is realized by use of an average filter, as shown in FIG. 2A and FIG. 3A, it is assumed that, at time t₁, intensities of signals of the individual five frequency bins 5b of the filter bank 5a which is the first one from the lower frequency side are represented by s1, s2, s3, s4, and s5, respectively. In this regard, with regard to the first filter bank 5a, when it is assumed that the intensity of the signal obtained by the smoothing processing by the first smoothing processing function is m₁₁ (see FIG. 2B and FIG. 3B), m₁₁ is equal to (s1+s2+s3+s4+s5)/5.

Similarly, as shown in FIG. 2B and FIG. 3B, the signals of the second filter bank 5a, the third filter bank 5a, the fourth filter bank 5a, and the fifth filter bank 5a are represented by m₂₁, m₃₁, m₄₁ and, m₅₁, respectively. In summary, in the present embodiment, for convenience of explanation, mji represents the intensity of the signal obtained by the smoothing processing realized by the first smoothing processing function on the signal of the j-th (“j” is a natural number) filter bank 5a at time tᵢ (“i” is a natural number) in the time axis.

The normalizer 6 normalizes the intensities of the signals passing through the individual filter banks 5a by the sum of the intensities of the signals passing through the plurality of predetermined filter banks 5a used in the recognition process by the recognizer 7. In this regard, in the following explanation, it is assumed that, for example, the total number of filter banks 5a in the frequency analyzer 5 is sixteen, and the plurality of predetermined filter banks 5a used for the recognition process are only the five filter banks which are the first to fifth filter banks from the lower frequency side. When the normalized intensity of the intensity m₁₁ of the signal passing through the first filter bank 5a at the time t₁ is n₁₁ (see FIG. 2C), the normalizer 6 can calculate the normalized intensity n₁₁ by use of the relation of n₁₁=m₁₁/(m₁₁+m₁₄+m₃₁+m₄₁+m₅₁).

Further, when each of the filter banks 5a is constituted by one frequency bin 5b, the normalizer 6 extracts the intensities of the signals passing through the individual filter banks 5a, and normalizes the intensities of the signals passing through the individual filter banks 5a by the sum of the intensities of these.

Further, the function of performing smoothing processing on intensities of signals of the individual frequency bins 5b in the time axis direction for each of the individual filter banks 5a which is performed by the smoothing processor 8 is defined as a second smoothing processing function. The second smoothing processing function can be realized by use of, for example, an average filter, a weighted average filter, a median filter, a weighted median filter, or the like. In a case where the second smoothing processing function is realized by use of an average filter of calculating an average of intensities of a signal at a plurality of (for example, three) points in the time axis direction, as shown in FIG. 3C, with regard to the first filter bank 5a, when it is assumed that the intensity of the signal obtained by the smoothing processing by the second smoothing processing function is m₁, m₁ is equal to (m₁₀+m₁₁+m₁₂)/3.

Similarly, when it is assumed that the intensities of the signals of the second filter bank 5a, the third filter bank 5a, the fourth filter bank 5a and the fifth filter bank 5a are represented by m₂, m₃, m₄ and m₅, m₂ is equal to (m₂₀+m₂₄+m₂₂)/3, and m₃ is equal to (m₃₀+m₃₁+m₃₂)/3, and m₄ is equal to (m₄₀+m₄₁+m₄₂)/3, and m₅ is equal to (m₅₀+m₅₁+m₅₂)/3.

In summary, in the present embodiment, for convenience of explanation, mₙ represents the intensity of the signal obtained by performing the smoothing processing by the first smoothing processing function on the signal of the n-th (“n” is a natural number) filter bank 5a and further performing the smoothing processing by the second smoothing processing function.

Additionally, it is preferable that the signal processing device 2 include a background signal estimator 9 and a background signal remover 10. The background signal estimator 9 is configured to estimate background signals (i.e., noise) included in the signals outputted from the individual filter banks 5a. The background signal remover 10 is configured to remove the background signals from the signals passing through the individual filter banks 5a.

It is preferable that the signal processing device 2 have operational modes including, for example, a first mode of estimating the background signals and a second mode of performing the recognition process and the first mode and the second mode be switched alternately at a predetermined time period (for example, 30 seconds) timed by a timer. In this regard, it is preferable that the signal processing device 2 operate the background signal estimator 9 in a period of the first mode, and remove the background signals with the background signal remover 10 and then perform the recognition process with the recognizer 7 in a period of the second mode. The period of the first mode and the period of the second mode are not limited to having the same length (for example, 30 seconds) but may be different lengths.

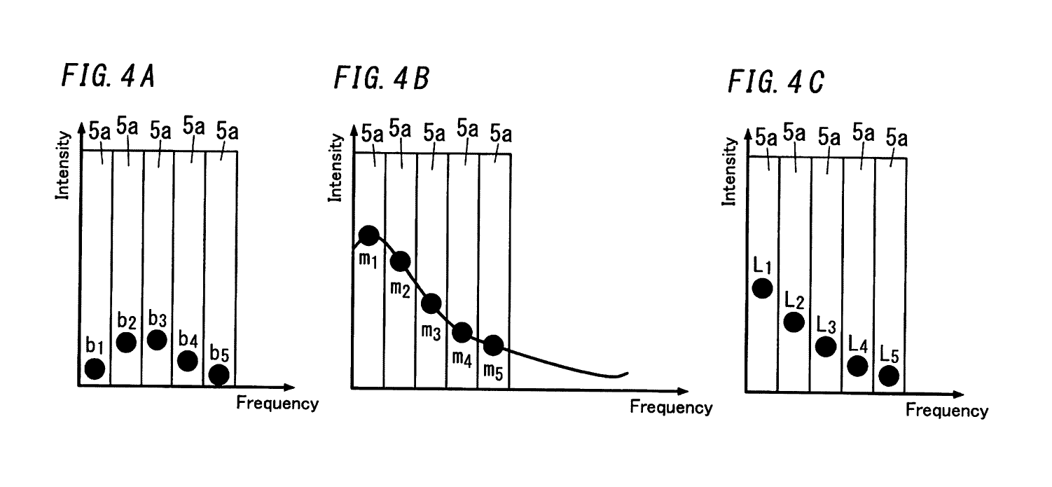

The background signal remover 10 may be configured to remove the background signals by subtracting the background signals from the signals outputted from the filter banks 5a, for example. In this case, the background signal remover 10 may include, for example, a subtractor configured to subtract the intensities b₁, b₂, . . . , (see FIG. 4A) of the background signals estimated by the background signal estimator 9 from the intensities of the signals m₁, m₂, . . . , (see FIG. 4B) passing through the individual filter banks 5a. FIG. 4C shows the intensities of the signals obtained by subtracting the background signals from the signals in the same filter bank 5a. In this regard, when L₁ represents the intensity of the signal of the first filter bank 5a from left, L₁ is equal to m₁−b₁.

Similarly, when it is assumed that the intensities of the signals obtained by subtraction of the background signals of the second filter bank 5a, the third filter bank 5a, the fourth filter bank 5a and the fifth filter bank 5a are represented by L₂, L₃, L₄ and L₅, L₂ is equal to m₂−b₂, and L₃ is equal to m₃−b₃, and L₄ is equal to m₄−b₄, and L₅ is equal to m₅−b₅.

The background signal estimator 9 may estimate the intensities of the signals obtained in the period of the first mode with regard to the individual filter banks 5a as the intensities of the background signals of the individual filter banks 5a, and then updates the background signals as needed. Further, the background signal estimator 9 may estimate an average of intensities of a plurality of signals obtained in the first mode with regard to each of the individual filter banks 5a as the intensity of the background signal of each of the individual filter banks 5a. In other words, the background signal estimator 9 may treat an average in a time axis of a plurality of signals obtained in advance for each of the individual filter banks 5a as the background signal. In this case, the background signal estimator 9 can have an improved estimation accuracy of the background signals.

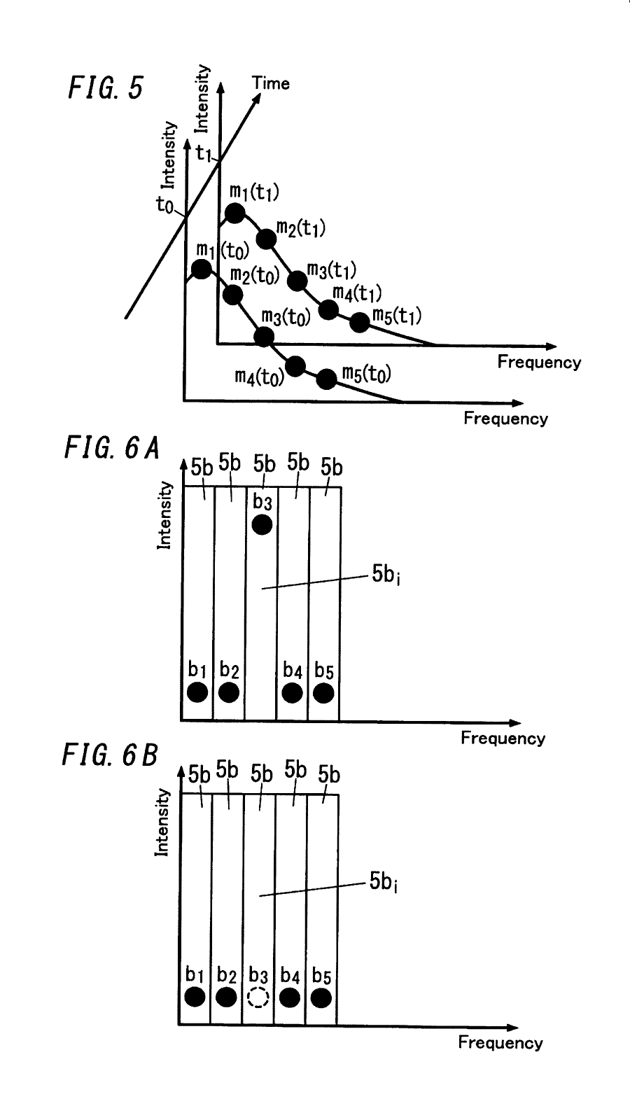

Further, the background signal remover 10 may treat an immediately preceding signal (i.e., a previous signal) of each of the filter banks 5a as the background signal. In this case, the signal processing device 2 may have a function of removing the background signals by subtracting the immediately preceding signals in the time axis before the signals are subjected to the normalization process by the normalizer 6. In summary, with regard to the signals passing through the individual filter banks 5a, the background signal remover 10 may have a function of removing the background signals by subtracting, from the intensities of the signals to be subjected to the normalization process, intensities of signals sampled at one point in the time axis before the signals to be subjected to the normalization process. In this case, for example, as shown in FIG. 5, when it is assumed that the signals of the individual filter banks 5a at the time t₁ to be subjected to the normalization process are represented by m₁(t₁), m₂(t₁), m₃(t₃), m₄(t₁) and m₅(t₁), and the signals at the time to immediately before the time t₁ are represented by m₁(t₀), m₂(t₀), m₃(t₀), m₄(t₀) and m₅(t₀), and the intensities of the signals after the subtraction are represented by L₁, L₂, L₃, L₄ and L₅, L₁ is equal to m₁(t₁)−m₁(t₀), and L₂ is equal to m₂(t₁)−m₂(t₀), and L₃ is equal to m₃(t₁)−m₃(t₀), and L₄ is equal to m₄(t₁)−m₄(t₀), and L₅ is equal to m₅(t₁)−m₅(t₀).

In some cases, depending on circumstances of use of the signal processing device 2, there is a possibility that the frequency bin 5b including a relatively large background signal (noise) may be known in advance. For example, in a case where apparatus to be energized by a commercial power source is present in a vicinity of the sensor device Se, there is a high possibility that relatively large background noise is included in the signal of the frequency bin 5b whose frequency band including a frequency (for example, 60 Hz, and 120 Hz) which is a relatively small multiple of a frequency of commercial power supply (for example, 60 Hz). In contrast, with regard to the sensor signal outputted when the object to be detected (intended object of detection) moves in the detection area, a frequency (Doppler frequency) of this sensor signal changes continuously according to a distance between the radio wave sensor 1 and the object and a moving speed of the object. In this case, the sensor signal does not occur constantly at a specific frequency.

In view of this, when the signal processing device 2 is configured so that each of the individual filter banks 5a includes a plurality of frequency bins 5b, one of the frequency bins 5b in which the background signal is constantly included may be treated as a particular frequency bin 5bᵢ. The background signal remover 10 may be configured to remove the background signal by not using an intensity of an actual signal of the particular frequency bin 5bᵢ but replacing the intensity of the actual signal of the particular frequency bin 5bᵢ by an intensity of a signal estimated based on intensities of signals of two frequency bins 5b adjacent to the particular frequency bin 5bᵢ.

The third frequency bin 5b from left in FIG. 6A is assumed to be the particular frequency bin 5bᵢ. The background signal remover 10 treats the signal (signal intensity b₃) of the particular frequency bin 5bᵢ as being invalid, and as shown in FIG. 6B, replaces it with the intensity b₃ of the signal component estimated based on the intensities b₂ and b₄ of the signal components of the two frequency bins 5b adjacent to the particular frequency bin 5bᵢ. In the estimation, the estimated intensity b₃ of the signal is an average of the intensities b₂ and b₄ of the signal components of the two frequency bins 5b adjacent to the particular frequency bin 5bᵢ, that is, (b₂+b₄)/2. In summary, when it is assumed that the i-th frequency bin 5b from the lower frequency side in the filter bank 5a is treated as the particular frequency bin 5bᵢ and the intensity of the signal of the particular frequency bin 5bᵢ is represented by bᵢ, bᵢ can be defined by an estimation formula of bᵢ=(bᵢ₋₁+bᵢ₊₁)/2.

Accordingly, the signal processing device 2 can reduce, in a short time, undesired effects caused by background signals (noise) of a particular frequency which occurs constantly. Therefore, the signal processing device 2 can have the improved detection accuracy of the intended object of detection.

The background signal remover 10 may be an adaptive filter configured to remove the background signal by filtering the background signal in a frequency domain (frequency axis).

The adaptive filter is a filter configured to adjust by itself a transfer function (filter coefficient) according to an adaptive algorithm (optimization algorithm), and can be realized by use of a digital filter. This type of adaptive filter may preferably be an adaptive filter using DCT (Discrete Cosine Transform). In this case, the adaptive algorithm of the adaptive filter may be an LMS (Least Mean Square) algorithm of DCT.

Alternatively, the adaptive filter may be an adaptive filter using FFT. In this case, the adaptive algorithm of the adaptive filter may be an LMS algorithm of FFT. The LMS algorithm gives an advantage of reducing a calculation amount relative to a projection algorithm and an RLS (Recursive Least Square) algorithm, and the LMS algorithm of DCT requires only calculation of real numbers, and therefore gives an advantage of reducing an amount of calculation relative to the LMS algorithm of FFT which requires calculation of complex numbers.

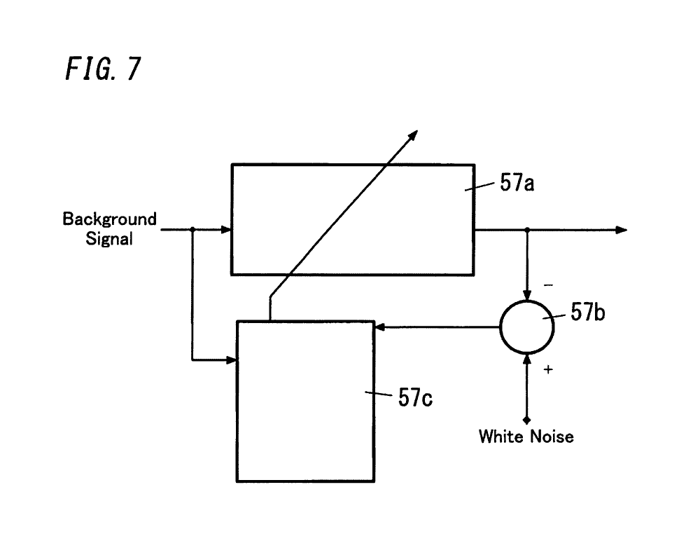

The adaptive filter has a configuration shown in FIG. 7, for example. This adaptive filter includes a filter 57a, a subtractor 57b, and an adaptive processor 57c. The filter 57a has a variable filter coefficient. The subtractor 57b outputs an error signal defined by a difference between an output signal of the filter 57a and a reference signal. The adaptive processor 57c generates a correction coefficient of a filter coefficient based on an input signal and the error signal according to the adaptive algorithm, and updates the filter coefficient. When background signals caused by thermal noises are given as an input signal of the filter 57a and the reference signal is a desired white noise, the adaptive filter can remove undesired background signals by filtering undesired background signals.

Further, by appropriately setting a forgetting factor of the adaptive filter, the background signal remover 10 may extract a frequency distribution of a signal obtained by filtering a long-term average background signal in a frequency axis. The forgetting coefficient is used in the calculation of updating the filter coefficient in order to exponentially decrease weights of previous data (filter coefficient) as the previous data is further away from the current data (filter coefficient), and exponentially increase weights of the previous data (filter coefficient) as the previous data is closer to the current data in the calculation of updating the filter coefficient. The forgetting coefficient is a positive number smaller than one, and for example is selected from a range of about 0.95 to 0.99.

The recognizer 7 performs the recognition process of detecting the object based on the distribution in the frequency domain of the normalized intensities obtained by filtering by the filter banks 5a and normalizing by the normalizer 6. In this regard, the meaning of “detect” includes “classify”, “recognize”, and “identify”.

The recognizer 7 detects the object by performing a pattern recognition process by principle component analysis, for example. This recognizer 7 operates according to a recognition algorithm using the principle component analysis. In order to operate such a type of recognizer 7, the signal processing device 2 preliminarily obtains learning sample data of a case where the intended object of detection is not present in the detection area of the radio wave sensor 1 and pieces of learning sample data individually corresponding to different motions of the intended object of detection. Further, the signal processing device 2 preliminarily stores in a database device 11, data obtained by performing the principle component analysis on pieces of the learning data. In this regard, the data stored in the database device 11 in advance may include data used for pattern recognition, which means category data associating the motion of the object, the projection vector, and a determination border value with each other.

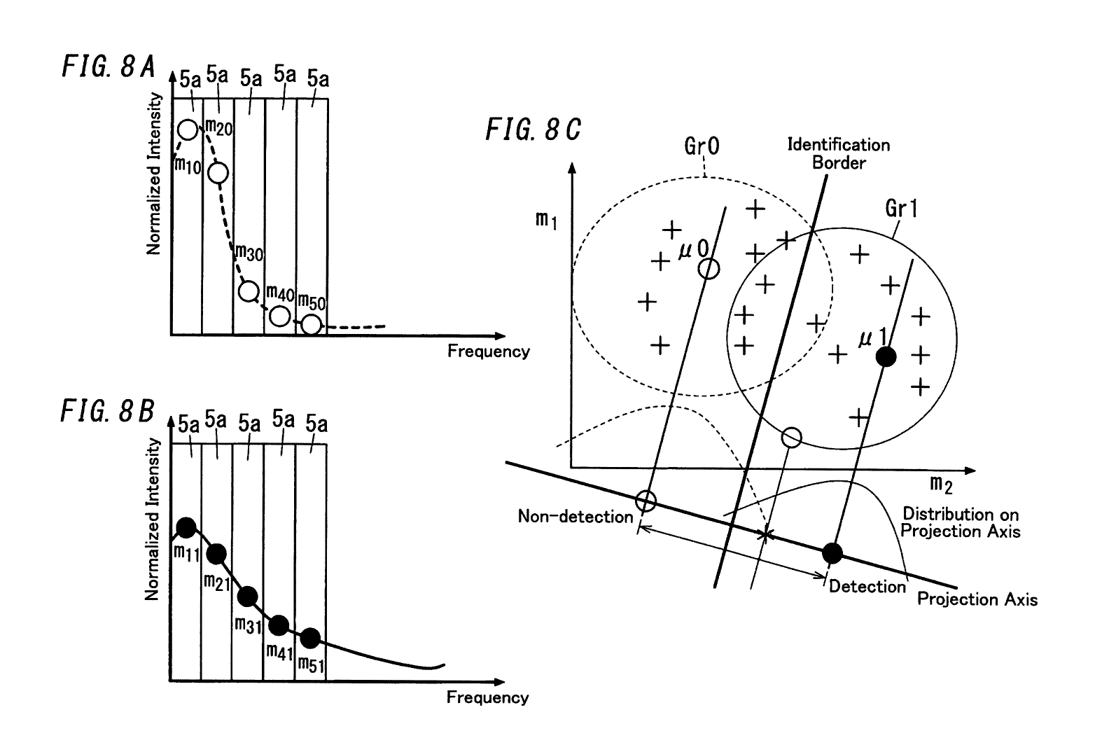

For convenience of explanation, it is assumed that FIG. 8A shows a distribution in the frequency domain of the normalized intensities corresponding to the learning sample data of the case where the intended object of detection is not present in the detection area of the radio wave sensor 1. Additionally, FIG. 8B shows a distribution in the frequency domain of the normalized intensities corresponding to the learning sample data of the case where the intended object of detection is present in the detection area of the radio wave sensor 1. In FIG. 8A, the normalized intensities of the signals passing through the individual filter banks 5a are represented by m₁₀, m₂₀, m₃₀, m₄₀ and m₅₀ from the lower frequency side. In FIG. 8B, the normalized intensities of the signals passing through the individual filter banks 5a are represented by m₁₁, m₂₁, m₃₁, m₄₁ and m₅₁ from the lower frequency side. In each of FIG. 8A and FIG. 8B, the sum of the normalized intensities of the signals passing through the three filter banks 5a on the lower frequency side is defined as a variable m₁, and the sum of the normalized intensities of the signals passing through the two filter banks 5a on the higher frequency side is defined as a variable m₂. In short, in FIG. 8A, m₁ is equal to m₁₀+m₂₀+m₃₀, and m₂ is equal to m₄₀+m₅₀. Further, in FIG. 8B, m₁ is equal to m₁₁+m₂₁+m₃₁, and m₂ is equal to m₄₁+m₅₁.

To imaginarily explain a two dimensional scatter diagram with orthogonal coordinate axes representing the two variables of m₁ and m₂, a projection axis, and a recognition border, FIG. 8C shows a two-dimensional graph of them. In FIG. 8C, a coordinate position of a scatter point (“+” in FIG. 8C) inside a region encircled by a broken line is represented by μ0 (m₂, m₁) and a coordinate position of a scatter point (“+” in FIG. 8C) inside a region encircled by a solid line is represented by μ1 (m₂, m₁). In the principle component analysis, a group Gr0 of data corresponding to the learning sample data of the case where the intended object of detection is not present in the detection area of the radio wave sensor 1 and a group Gr1 of data corresponding to the learning sample data of the case where the intended object of detection is present in the detection area are decided in advance. Further, in the principle component analysis, in FIG. 8C, the projection axis is determined to satisfy a condition that a difference between averages of distributions (schematically shown by a broken line and a solid line) of data obtained by projecting, onto the projection axis, the scatter points inside the regions encircled by the broken line and the solid line is maximized, and a further condition that variances of the distributions are maximized. Thus, in the principle component analysis, a projection vector can be obtained for each learning sample.

Besides, the signal processing device 2 includes an outputter 12 configured to output the detection result from the recognizer 7. When the recognizer 7 recognizes the intended object of detection, the outputter 12 outputs a high level signal (e.g., corresponding to “1”) as an output signal indicating that the object has been detected. When the recognizer 7 does not recognize the intended object of detection, the outputter 12 outputs a low level signal (e.g., corresponding to “0”) as an output signal indicating that the intended object of detection has not been detected yet.

In FIG. 1, components of the signal processing device 2 except the amplifier 3, the A/D converter 4, the outputter 12 and the database device 11 can be realized by the microcomputer performing appropriate programs.

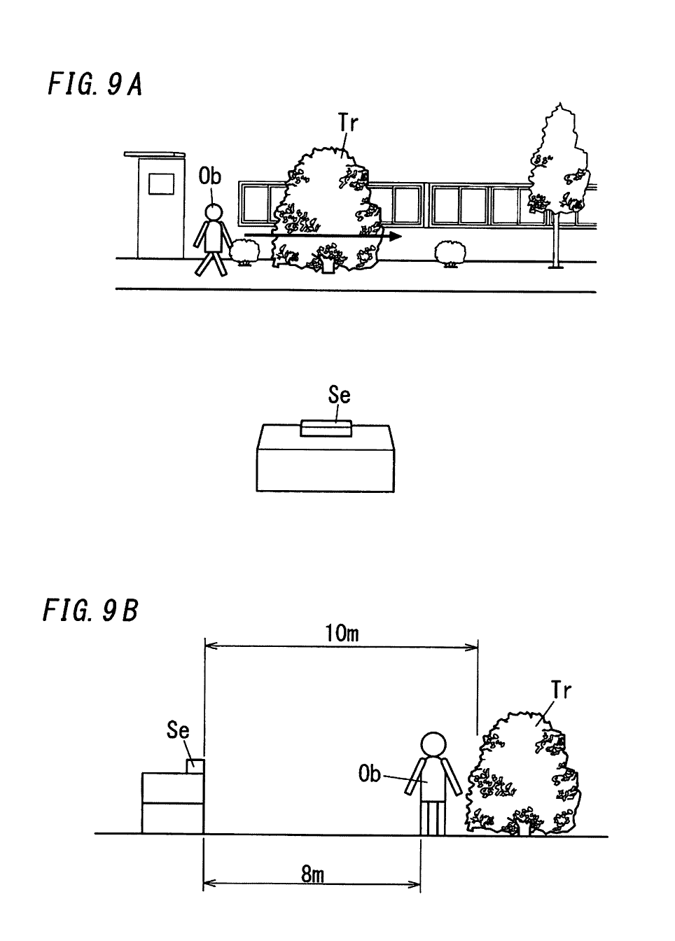

Hereinafter, a relation between one example of the sensor signal outputted from the radio wave sensor 1 and the output signal outputted from the outputter 12 is described with reference to FIG. 9A to FIG. 12.

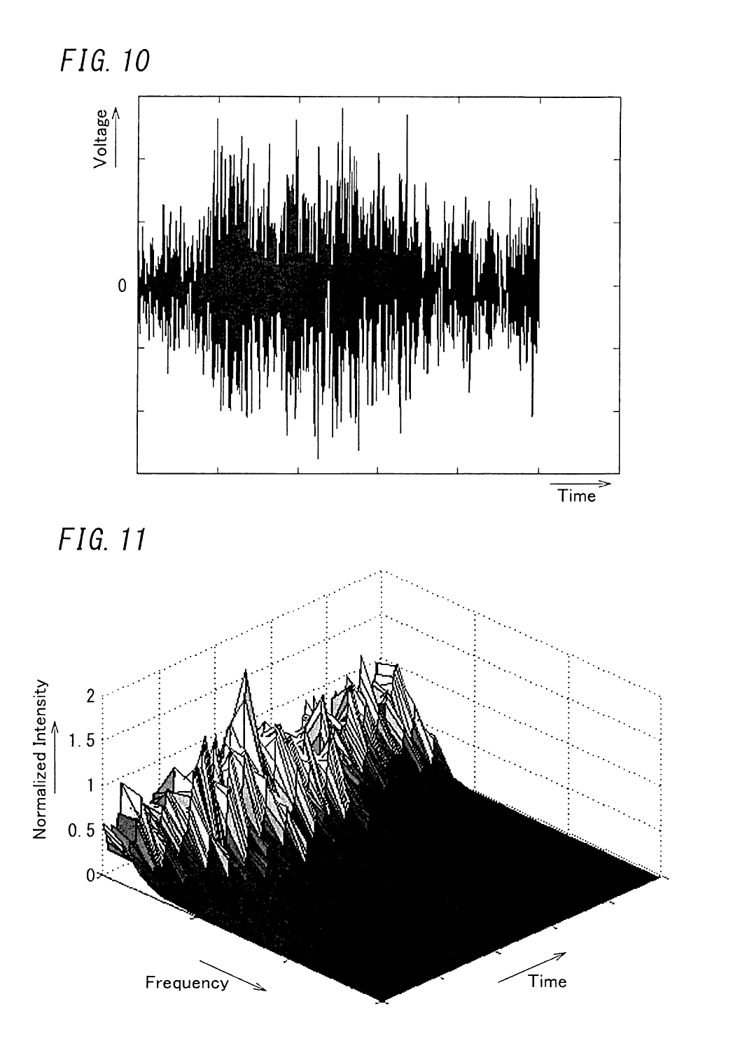

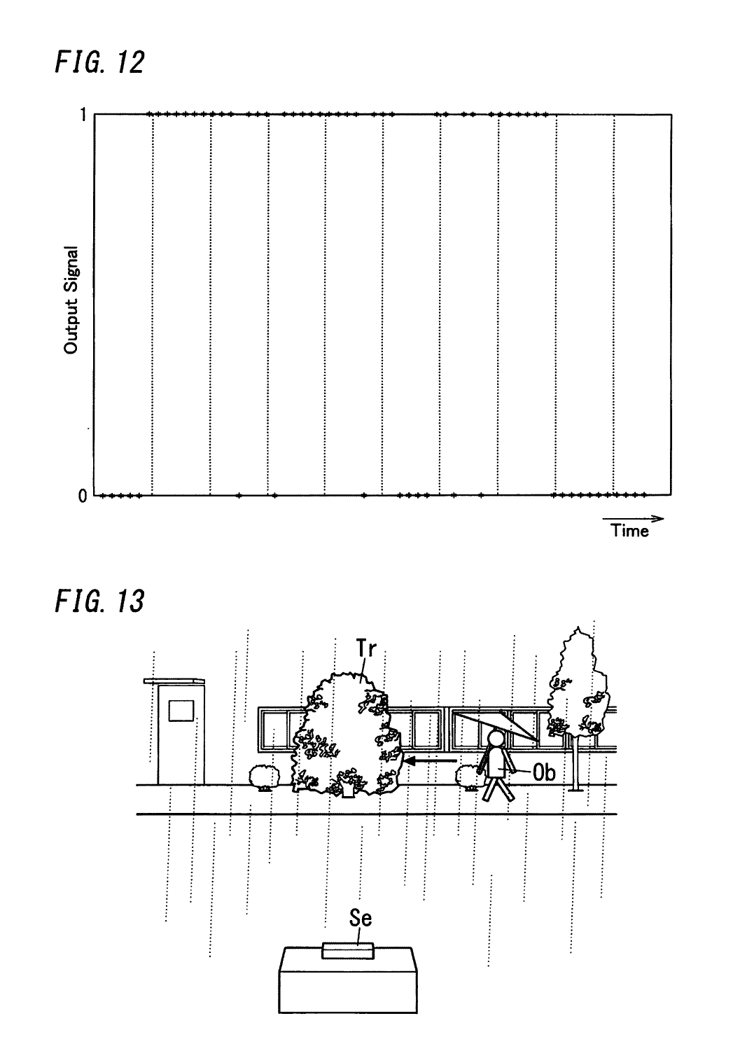

FIGS. 9A and 9B shows a usage example of the sensor device Se including the radio wave sensor 1 and the signal processing device 2, and indicates that the object Ob of detection interest is a person and a tree Tr which is not of detection interest is present in the detection area in the outdoors. FIG. 10 shows, in the usage example, one instance of the sensor signal outputted from the radio wave sensor 1 when the object Ob moves a distance of 6.7 m at the moving speed of 1 m/s in front of the tree Tr while branches and leaves of the tree Tr sway. Note that, a distance between the radio wave sensor 1 and the tree Tr is about 10 m, and a distance between the radio wave sensor 1 and the object Ob is about 8 m. FIG. 11 is a diagram illustrating distributions in the frequency domain and the time axis domain of the normalized intensities. FIG. 12 shows the output signal of the outputter 12, and it is confirmed that the probability of false detection caused by motion of the unintended object of detection can be reduced.

In view of the distribution in the frequency domain of the normalized intensities, when the object in the detection area is a tree, branches and leaves of the tree may sway but the tree itself does not move. Hence, compared with a case where the object is a person walking in the detection area, the frequency distribution shows signal components on the lower frequency region. Whereas, in the case where the object is a person walking in the detection area, the frequency distribution shows a mountain shape distribution with a center frequency near a frequency corresponding to the walking speed. Therefore, there may be seen a clear difference between the frequency distributions.

The unintended object of detection in the detection area is mainly an object which is not movable as a whole but can make motion. When the detection area of the radio wave sensor 1 is set in the outdoors, the unintended object of detection present in the detection area is not limited to the tree Tr and may be, for example, an electric wire swaying in the wind.

Hereinafter, a relation between another example of the sensor signal outputted from the radio wave sensor 1 and the output signal outputted from the outputter 12 is described with reference to FIG. 13 to FIG. 16.

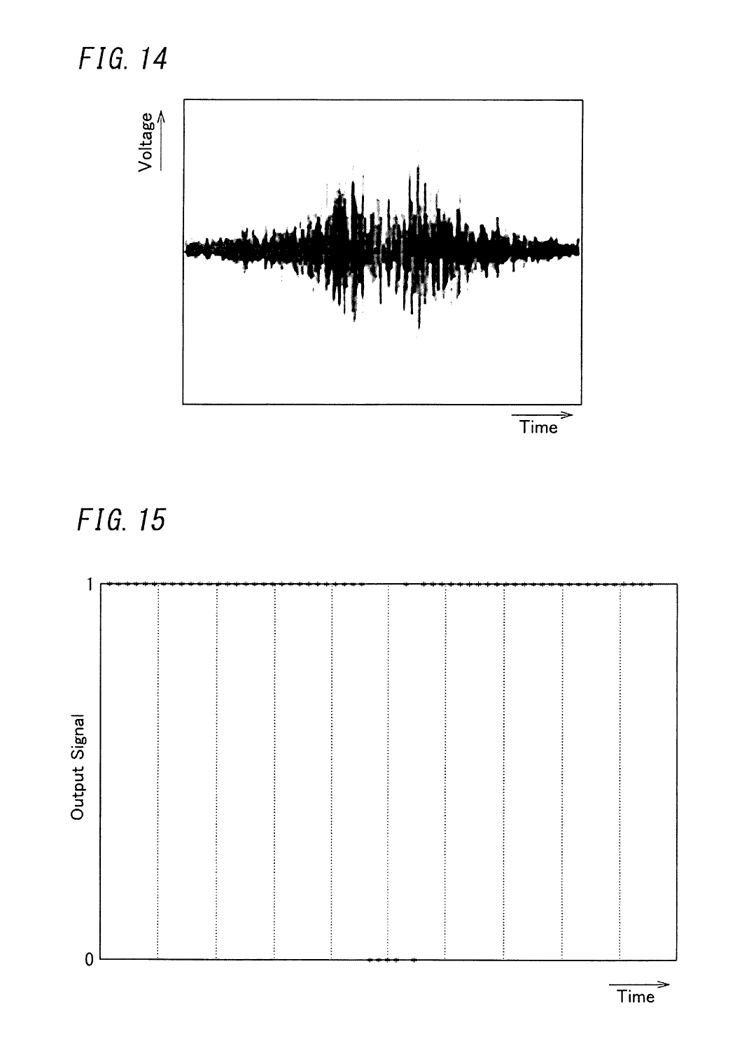

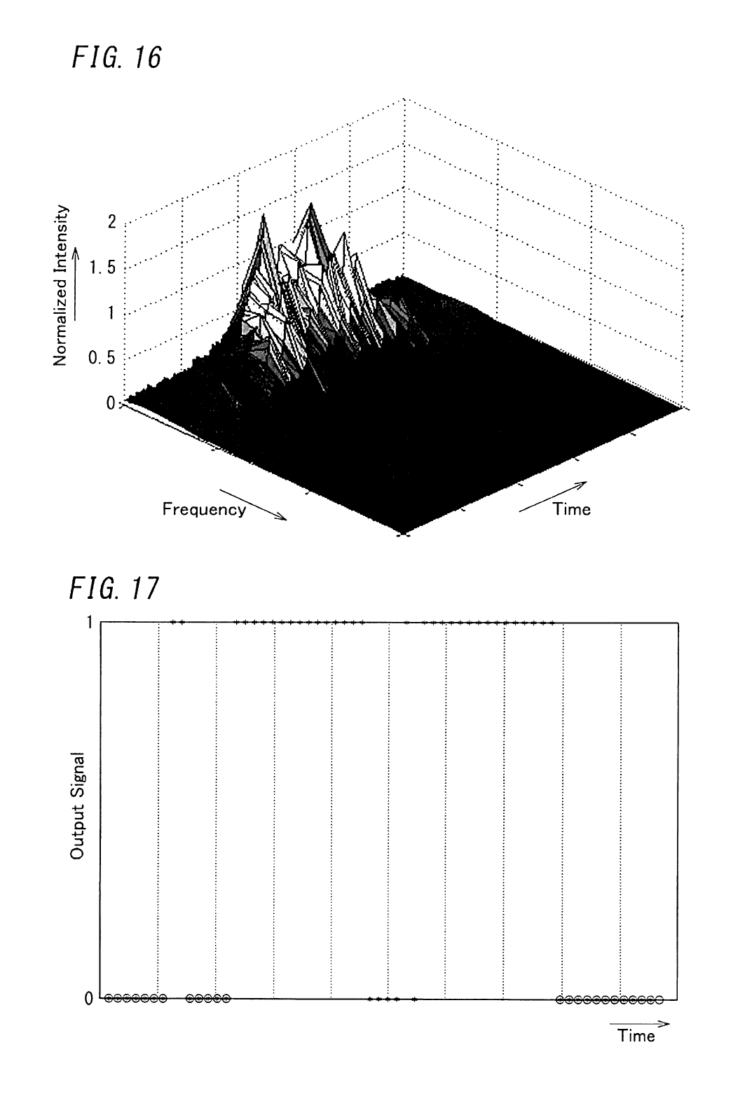

FIG. 13 shows a usage example of the sensor device Se including the radio wave sensor 1 and the signal processing device 2, and indicates that the object Ob of detection interest is a person and it rains in the detection area in the outdoors. FIG. 14 shows, in the usage example, one instance of the sensor signal outputted from the radio wave sensor 1 when the object Ob moves a distance of 6.7 m at the moving speed of 1 m/s. FIG. 15 shows the output signal of the outputter 12 in a case where the removal of the background signals by the background signal remover 10 is not conducted. FIG. 16 shows the distributions in the frequency domain and the time axis domain of the normalized intensities in a case where the removal of the background signals by the background signal remover 10 is conducted. FIG. 17 shows the output signal of the outputter 12 in the case where the removal of the background signals by the background signal remover 10 is conducted. As compared with FIG. 15, it is confirmed that the probability of false detection caused by motion of the unintended object of detection (in this instance, raindrop) can be reduced.

Further, when the detection area of the radio wave sensor 1 is set in the indoors, the unintended object of detection present in the detection area may be, for example, a device (e.g., an electric fan) including a movable body (e.g., a blade in a case of an electric fan).

It is preferable that the signal processing device 2 allows change of the aforementioned determination border value according to settings inputted from the outside. Accordingly, the signal processing device 2 can adjust required probabilities of miss detection and false detection according to usage. For example, with regard to a usage example where the intended object of detection is a person, and a lighting load is turned on and off according to the output signal from the outputter 12, the false detection may be acceptable to some extent to avoid such miss detection that detection of a person coming into the detection area of the radio wave sensor 1 is failed.

In the signal processing device 2 of the present embodiment described above, the frequency analyzer 5 converts the sensor signal (time axis signal) outputted from the A/D converter 4 into the frequency domain signal, and extracts, by use of the group of individual filter banks 5a with different frequency bands, the signals of the individual filter banks 5a. The recognizer 7 performs the recognition process of detecting the object based on the frequency distribution calculated from signal intensities based on the signals of the individual filter banks 5a.

Even when the sensor signal has a short time period (e.g., several tens of ms) in which the frequency analysis such as DCT is performed, the sensor signal shows a unique frequency distribution (statistical distribution in a frequency domain) which differs among the objects. When the feature of the frequency distribution is used for detection of the object, the signal processing device 2 can separate and recognize the objects different in the frequency distribution. Therefore, the signal processing device 2 can reduce the probability of the false detection caused by motion of the unintended object of detection. In summary, the signal processing device 2 can separate and detect the objects which are statistically different in the frequency distribution calculated from the intensities of the signals individually passing through the plurality of filter banks 5a, and thus the probability of the false detection can be reduced.

Further, in the filter bank 5a using FFT, in some cases, there is need to perform a process of multiplying a predetermined window function with the sensor signal before the FFT process, in order to reduce a side-lobe outside a desired frequency band (pass band). The window function may be selected from a rectangular window, a Gauss window, a hann window, and a hamming window, for example. In contrast, in the filter bank 5a using DCT, there is no need to use the window function. Therefore, the window function can be realized by a simple digital filter.

Further, the filter bank 5a using DCT is a process based on calculation of real numbers whereas the filter bank 5a using FFT is a process based on calculation of complex numbers (i.e., calculation of intensities and phases), and hence according to the filter bank 5a using DCT, an amount of calculation can be reduced. Further, in comparison between DCT and FFT with the same processing points, the frequency resolution of DCT is half of the frequency resolution of FFT. Hence, according to DCT, hardware resource such as the database device 11 can be down sized. For example, in the signal processing device 2, when the sampling rate of the A/D converter 4 is 128 per second (e.g., the sampling frequency is 1 kHz), a DCT bin 5b has a width of 4 Hz whereas an FFT bin 5b has a width of 8 Hz. Note that, these numerical values are merely examples, and there is no intent of limitations.

Further, in a period when the recognizer 7 continuously detects the intended object of detection in the time axis, the signal processing device 2 can use the normalized intensities outputted from the normalizer 6 in the period as the background signals and remove them. Therefore, the recognition accuracy can be improved.

The recognizer 7 may be configured to detect the object based on the pattern recognition process by the principle component analysis, or may be configured to detect the object based on another pattern recognition process. For example, the recognizer 7 may be configured to detect the object based on a pattern recognition process by KL transform, for example. When the signal processing device 2 is configured so that the recognizer 7 performs the pattern recognition process by the principle component analysis or the pattern recognition process by KL transform, an amount of calculation at the recognizer 7 and an amount of a capacity of the database device 11 can be reduced.

The recognizer 7 may be configured to perform the recognition process of detecting the object based on a component ratio of the normalized intensities of the individual filter banks 5a outputted from the normalizer 6.

This type of recognizer 7 may be, for example, configured to detect the object by performing the recognition process based on multiple linear regression analysis. In this case, the recognizer 7 operates according to a recognition algorithm using the multiple linear regression analysis.

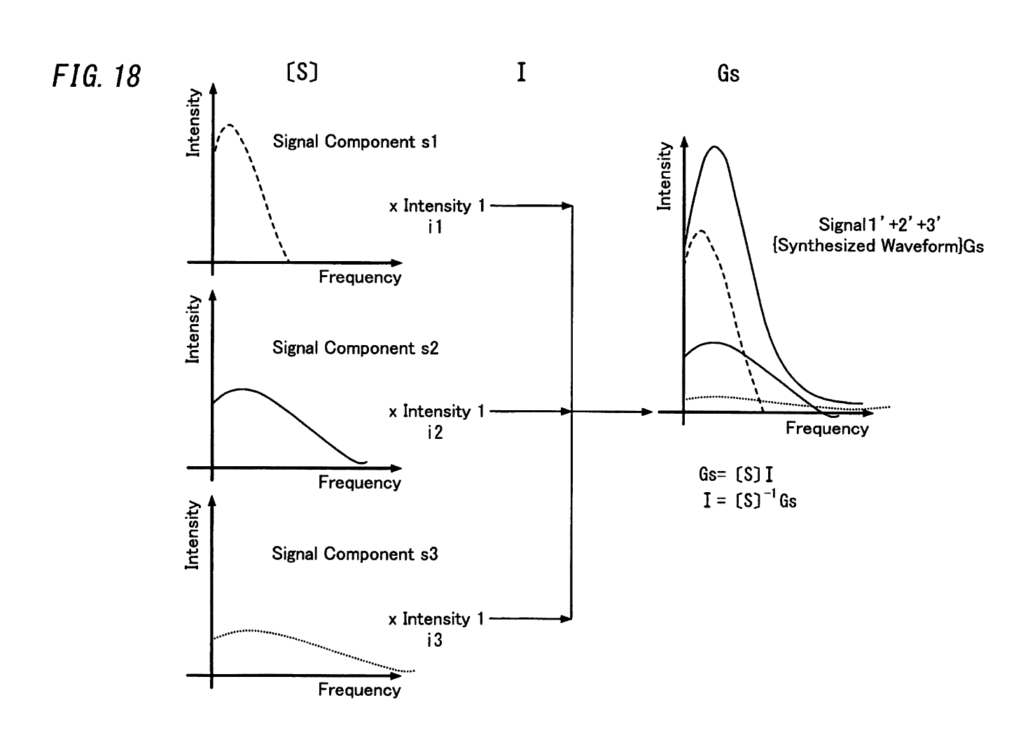

In order to use such a type of recognizer 7, the signal processing device 2 may preliminarily obtain learning data corresponding to different motions of the intended object of detection in the detection area of the radio wave sensor 1. The signal processing device 2 may preliminarily store, in the database device 11, data obtained by performing the multiple linear regression analysis on the learning data. FIG. 18 shows a synthesized waveform Gs of synthesis of a signal component s1, a signal component s2, and a signal component s3. According to the multiple linear regression analysis, the synthesized waveform Gs can be separated into the signal components s1, s2, and s3 by presumption, even when types of the signal components s1, s2, and s3, the number of signal components, and intensities of the signal components s1, s2, and s3 are unknown. In FIG. 18, [S] denotes a matrix whose matrix elements are the signal components s1, s2, and s3, and [S]⁻¹ denotes an inverse matrix of [S], and “I” denotes the component ratio (coefficient) of the normalized intensity. In this regard, the data preliminarily stored in the database device 11 serves as data used in the recognition process, and data associating the motion of the object with the signal components s1, s2, and s3.

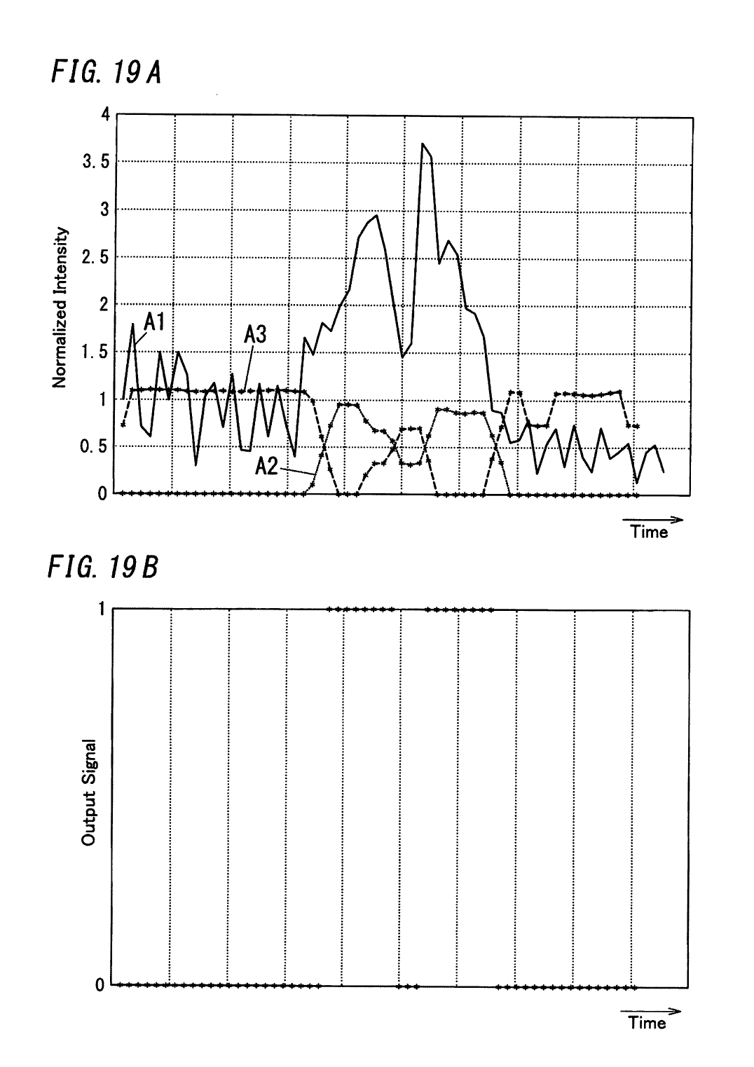

FIG. 19A shows a lateral axis denoting the time and a vertical axis denoting the normalized intensity. FIG. 19A shows A1 which represents data (corresponding to the aforementioned synthesized waveform Gs) in the time axis of the normalized intensities outputted from the normalizer 6 when a person who is the intended object of detection moves a distance of 10 m at the moving speed of 2 m/s under an electric wire swaying in the detection area in the outdoors. Further, FIG. 19A also shows signal components A2 and A3 which are separated from data A1 by the multiple linear regression analysis. In this regard, the signal component A2 is a signal component derived from motion of the person, and the signal component A3 is a signal component derived from sway of the electric wire. FIG. 19B shows the output signal of the outputter 12. In a case where A2 is larger than A3, the recognizer 7 determines that the intended object of detection is present, and sets the output signal of the outputter 12 to a high level (corresponding to “1”, in this instance). In other cases, the recognizer 7 determines that the intended object of detection is not present, and sets the output signal of the outputter 12 to a low level (corresponding to “0”, in this instance). As apparent from FIG. 19B, it is confirmed that the probability of the false detection caused by motion of the unintended object of detection (in this instance, the electric wire) can be reduced.

It is preferable that the signal processing device 2 allows change of the aforementioned determination condition (A2>A3) according to settings inputted from the outside. For example, it is preferable that the determination condition is set to A2>α×A3 and the coefficient α be allowed to be changed according to the settings inputted from the outside. Accordingly, the signal processing device 2 can adjust required probabilities of miss detection and the false detection according to usage.

Note that, the recognizer 7 may detect the intended object of detection based on the feature of the aforementioned frequency distribution and the component ratio of the normalized intensities.

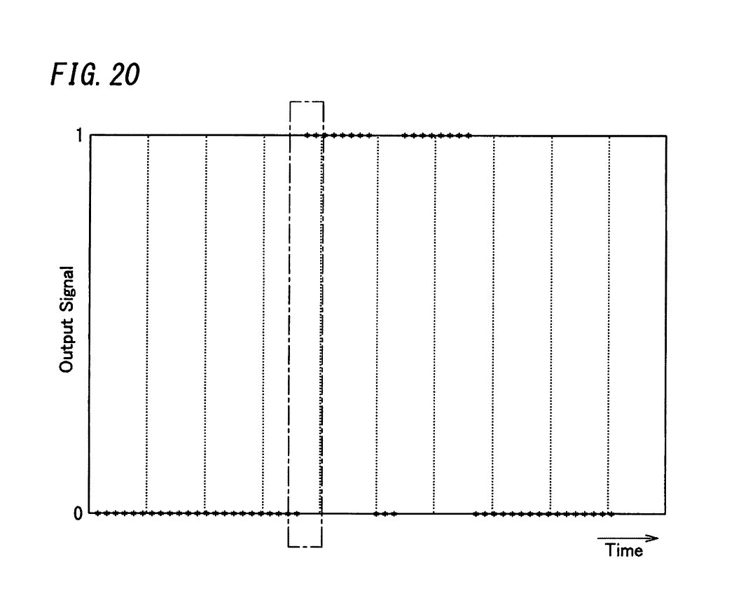

The recognizer 7 may detect the object based on majority decision based on results obtained by performing the recognition process an odd number of times. For example, in FIG. 20, based on the majority decision based on the results of the three recognition processes with regard to region surrounded by a dashed-dotted line, the value of the output signal of the outputter 12 is set to “1”.

Therefore, the signal processing device 2 can have the improved identification accuracy by the recognizer 7.

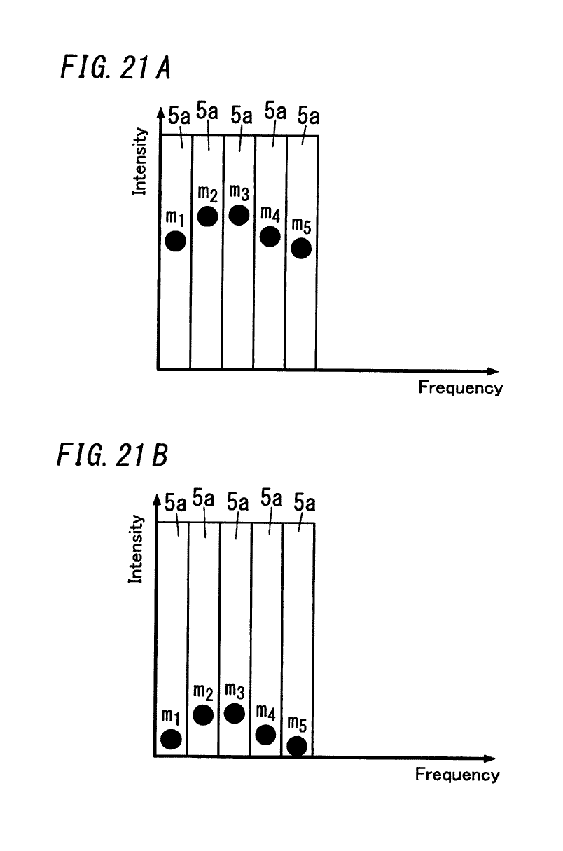

Further, the signal processing device 2 may be configured to allow the recognizer 7 to perform the recognition process or treat the recognition result by the recognizer 7 as being valid, only when the sum or weighted sum of intensities of signal components of a plurality of predetermined filter banks 5a before normalization by the normalizer 6 is equal to or larger than a threshold value. FIG. 21A and FIG. 21B relate to examples in which the intensities of the signals of the individual filter banks 5a before being normalized by the normalizer 6 are represented by m₁, m₂, m₃, m₄ and m₅ from the lower frequency side. FIG. 21A shows an example in which the sum of intensities [m₁+m₂+m₃+m₄+m₅] is equal to or larger than the threshold value (E1). FIG. 21B shows an example in which the sum of intensities [m₁+m₂+m₃+m₄+m₅] is smaller than the threshold value (E1).

Accordingly, the signal processing device 2 can reduce the probability of the false detection. For example, the recognizer 7 is configured to detect the object by the frequency distribution derived based on the normalized intensities of the signal components. In this case, when the intended object of detection is not present in the detection area of the radio wave sensor 1 but background noise is inputted, there is a probability that the recognizer 7 determines that the feature of the frequency distribution of the intensities of the signals at this time resembles the feature of the frequency distribution of a case where the intended object of detection is present in the detection area, and thus causes the false detection. In view of this, to reduce the probability of the false detection, the signal processing device 2 determines whether to perform the recognition process, based on pre-normalized intensities of signals.

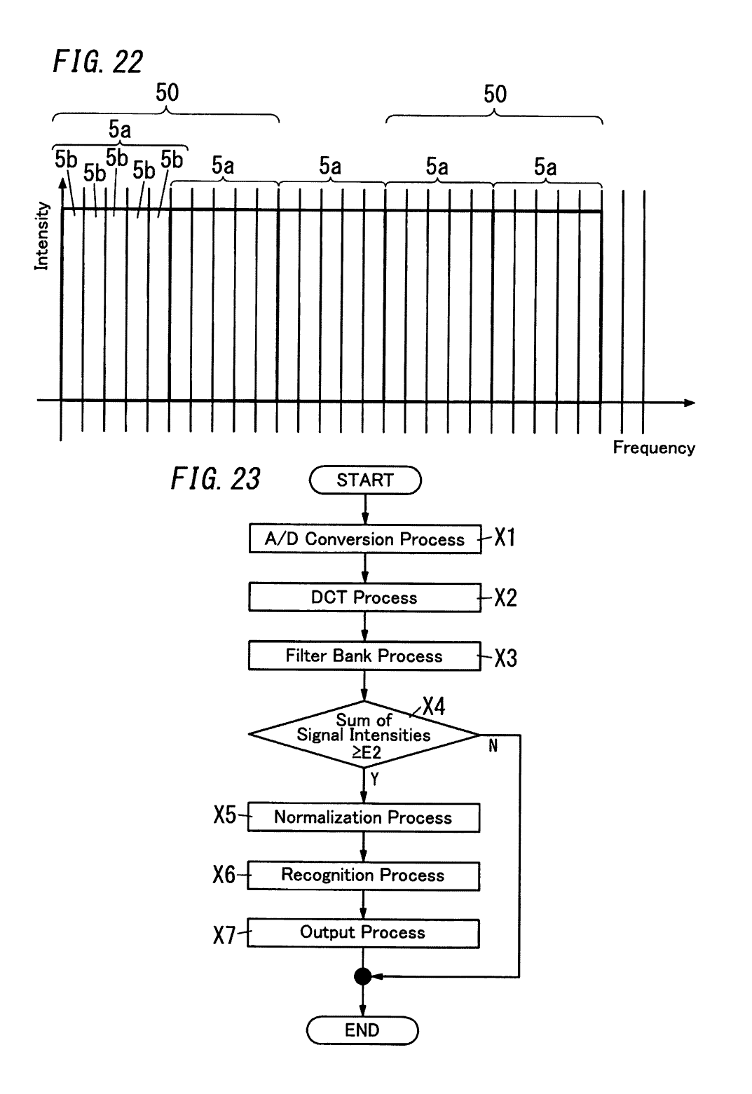

Further, a plurality of predetermined filter banks 5a before normalization by the normalizer 6 may be treated as one group 50 of filter banks (see FIG. 22). In this case, the signal processing device 2 may determine whether the sum or weighted sum of pre-normalized intensities of signal components is equal to or larger than a threshold value E2 for each of a plurality of groups 50 of filter banks. In more detail, the signal processing device 2 may be configured to, only when, with regard to any of the groups 50 of filter banks, the sum of pre-normalized intensities of signal components is equal to or larger than the threshold value E2, allow the recognizer 7 to perform the recognition process or treat a result of the recognition process by the recognizer 7 as being valid. Or, the signal processing device 2 may be configured to, only when, with regard to all of the groups 50 of filter banks, the sum or weighted sum of pre-normalized intensities of signal components is equal to or larger than the threshold value E2, allow the recognizer 7 to perform the recognition process or treat a result of the recognition process by the recognizer 7 as being valid. Hereinafter, a series of processes including this determination process is described with reference to a flow chart shown in FIG. 23. Note that, hereinafter, the phrase “the sum or weighted sum of pre-normalized intensities of signal components” is abbreviated as the sum of pre-normalized intensities of signal components.

First, the A/D converter 4 performs an A/D conversion process of converting the sensor signal amplified by the amplifier 3 into the digital sensor signal and outputting the digital sensor signal (X1). Next, the frequency analyzer 5 performs a filter bank process of converting the sensor signal outputted from the A/D converter 4 into the frequency domain signal (frequency axis signal) by DCT process (X2) and extracting signals of the individual filter banks 5a (X3). For example, in a case of DCT with 128 points, it is considered that one hundred twenty eight frequency bins 5b are divided into bundles of five frequency bins 5b and thus twenty five filter banks 5a are obtained.

Next, for example, as shown in FIG. 22, with regard to each of two groups 50 of filter bank on the lower frequency side and the higher frequency side, the signal processing device 2 calculates the sum of pre-normalized intensities of signals of a plurality of filter banks 5a constituting the group 50 of filter banks. Thereafter, the signal processing device 2 performs a threshold-based determination process of determining whether the sum of intensities of signals is equal to or larger than the threshold value E2 for each group 50 of filter banks (X4).

When the sum of intensities of signals of any of the groups 50 of filter banks is equal to or larger than the threshold value E2, the signal processing device 2 determines that the amplitude of the sensor signal outputted from the radio wave sensor 1 is large and therefore the possibility that the sensor signal is derived from background noise is low, and performs a normalization process by the normalizer 6 (X5). In short, the normalizer 6 normalizes intensities of signals passing through the individual filter banks 5a and outputs normalized intensities.

Thereafter, the recognizer 7 of the signal processing device 2 performs the recognition process of recognizing the feature of the distribution of intensities of signal of individual frequency components of the plurality of filter banks 5a obtained by normalization, and determining whether the feature is derived from the intended object of detection (X6). When the recognizer 7 detects the intended object of detection, the outputter 12 performs an output process of outputting the detection signal (X7).

In contrast, when the sum of intensities of signals of each of all the groups 50 of filter banks is smaller than the threshold value E2, the signal processing device 2 determines that the amplitude of the sensor signal outputted from the radio wave sensor 1 is small and therefore the possibility that the sensor signal is derived from background noise is high. When determining that the possibility that the sensor signal is derived from background noise is high, the signal processing device 2 does not perform subsequent processes including the normalization process by the normalizer 6 (X5 to X7).

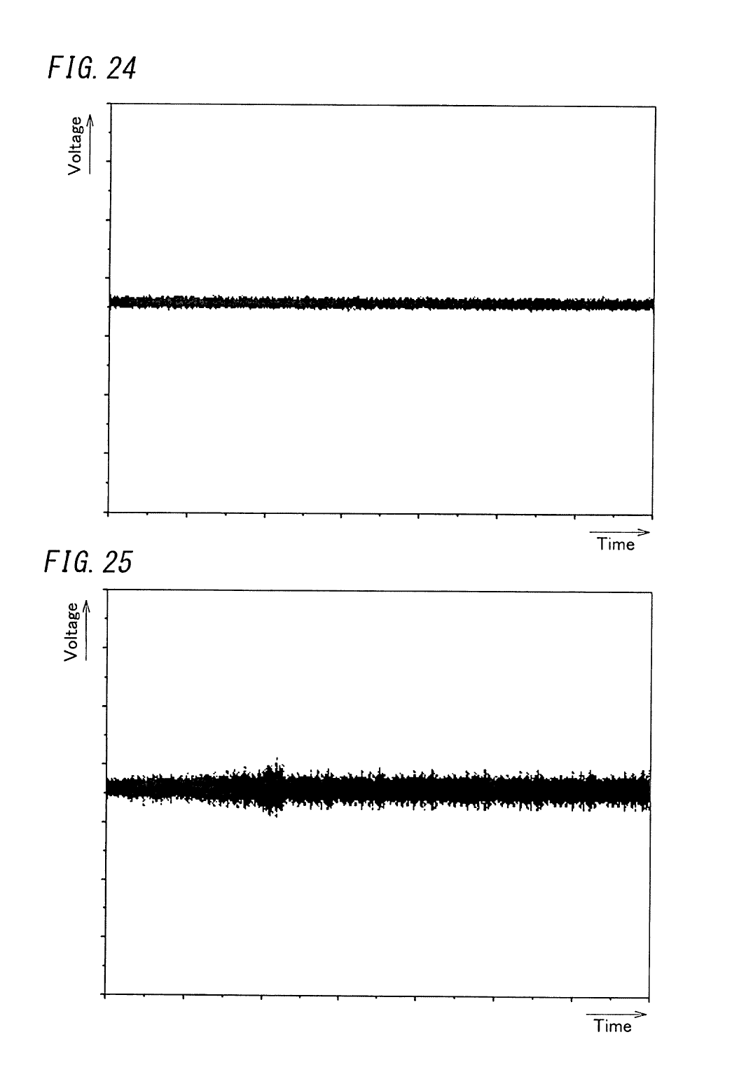

FIG. 24 shows one example of the sensor signal (a signal pattern of background noise) outputted from the radio wave sensor 1 in a case where the intended object of detection is not present. Further, FIG. 25 shows one example of the sensor signal outputted from the radio wave sensor 1 in a case where the intended object of detection is present. The sensor signal derived from the background noise shown in FIG. 24 is smaller in amplitude than the sensor signal at the time of detection shown in FIG. 25. Note that, in each of FIG. 24 and FIG. 25, a lateral axis denotes the time and a vertical axis denotes the intensity (voltage) of the sensor signal.

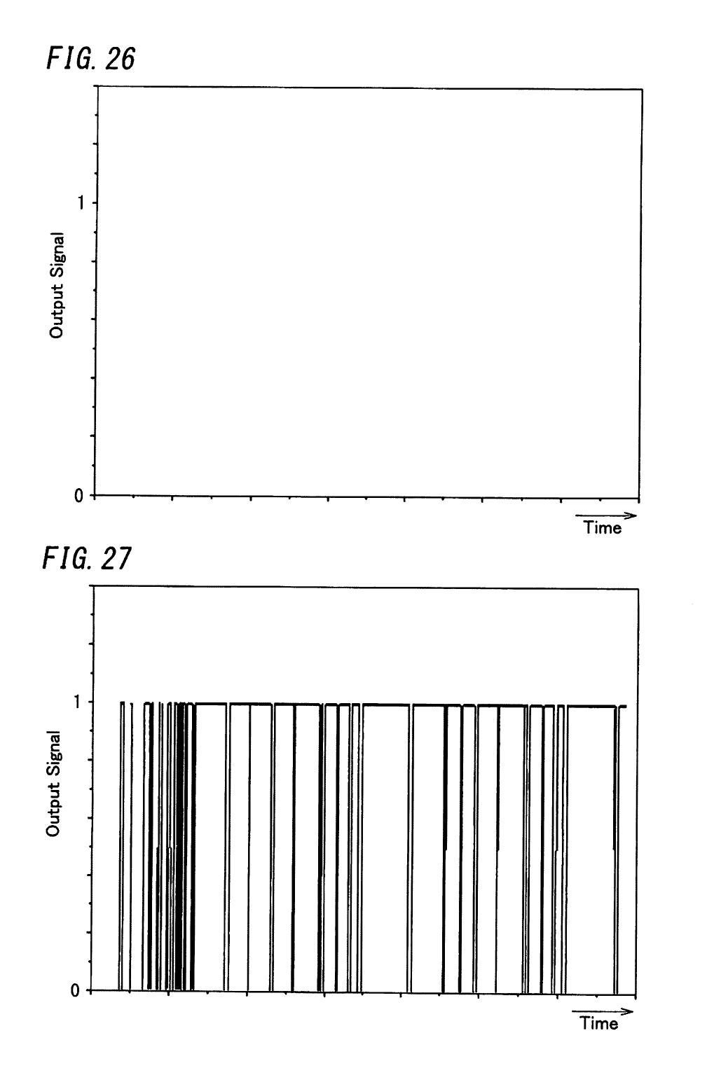

In a case where the signal processing device 2 performs the threshold-based determination process of the aforementioned step X4, the output signal of the outputter 12 resulting from the sensor signal (background noise) of FIG. 24 is shown as in FIG. 26, and the output signal of the outputter 12 resulting from the sensor signal (the intended object of detection is present) of FIG. 25 is shown as in FIG. 27. Therefore, it is confirmed that by appropriately selecting the threshold value E2, it is possible to reduce the probability of the false detection caused by the background noise, and to, when the intended object of detection is present, detect the object more accurately. Note that, in FIG. 26 and FIG. 27, the output signal of the outputter 12 has a high level (corresponding to “1” in this instance) when the recognizer 7 recognizes the intended object of detection, and has a low level (corresponding to “0” in this instance) when the recognizer 7 does not recognize the intended object of detection.

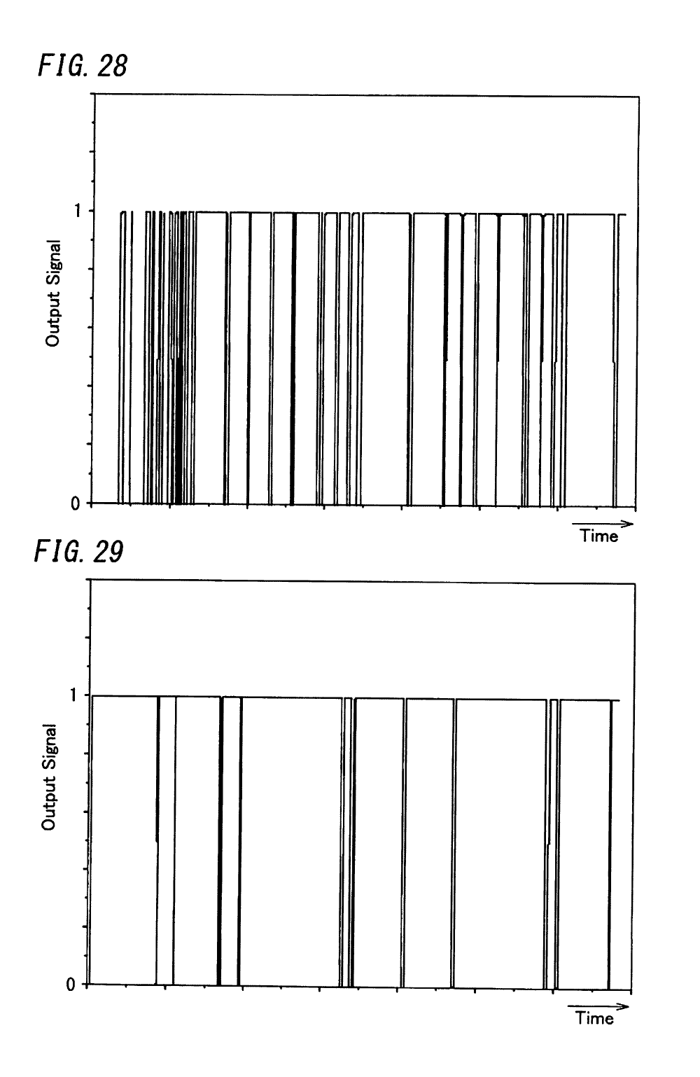

In contrast, when the threshold value E2 is set to zero, the output signal of the outputter 12 resulting from the sensor signal (background noise) of FIG. 24 is shown as in FIG. 28, and the output signal of the outputter 12 resulting from the sensor signal (the intended object of detection is present) of FIG. 25 is shown as in FIG. 29. In a case where the signal processing device 2 does not perform the threshold-based determination process of the aforementioned step X4, the false detection caused by background noise may frequently occur. Further, also in a case where the intended object of detection is present, the value of the output signal of the outputter 12 is switched to “1” frequently. As understood from the above, when the signal processing device 2 does not perform the threshold-based determination process of the aforementioned step X4, there is a probability of occurrence of the false detection caused by background noise.

The signal processing device 2 of the present embodiment includes a parameter adjuster 14, and the parameter adjuster 14 is configured to change a parameter for adjusting detection sensitivity of the object in the recognition process performed by the recognizer 7. The parameter for adjusting the detection sensitivity may include the aforementioned threshold values E1 and E2, for example.

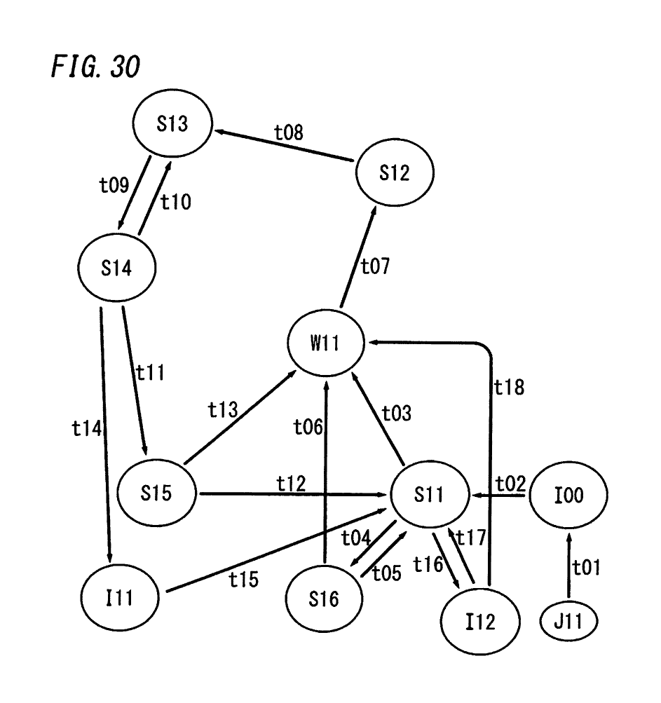

The signal processing device 2 includes a state machine for performing the aforementioned processes. FIG. 30 shows basic operation (operation without using a level setter 13) of this state machine. Note that, in the following explanation, the aforementioned threshold value E2 is selected as a parameter to be adjusted by the parameter adjuster 14.

First, at the time of supplying power or immediately after the time of canceling reset, the state machine starts to operate from an idle state J11. Thereafter, the state machine changes from the idle state J11 to a state I00 (t01).

In some cases, a level of background noise in an ambient environment of the radio wave sensor 1 may change depending on causes such as increase or decrease in an element changing the level of the background noise. Hence, even after the threshold value E2 for the threshold-based determination process is set, once the level of the background noise changes, the current setting cannot lead expected operation. As a result, the false detection may occur, or the non-detection state may occur even when the intended object of detection exists.

In view of this, in the state NO changed from the idle state J11, the parameter adjuster 14 performs operation of setting the threshold value E2 for the threshold-based determination process in an activating period, and after setting of the threshold value E2, the state machine changes to the state S11 (t02). In more detail, in the state NO, the A/D conversion process, the DCT process, and the filter bank process are conducted on the sensor signal (the steps X1 to X3 in FIG. 23), and thus intensities of signals of the individual filter banks 5a are measured. Thereafter, the parameter adjuster 14 calculates the threshold value E2 by multiplying the average of the intensities of the signals of all of or a plurality of filter banks 5a by a predetermined coefficient, and thus uses the calculated threshold value E2 as a threshold value in the subsequent threshold-based determination process. Further, an available range of the threshold value E2 may be delimited by predetermined upper and lower limits. The upper limit of the threshold value E2 is selected for ensuring the detection accuracy of the intended object of detection. The lower limit of the threshold value E2 is selected for ensuring the effect of preventing the false detection caused by background signal.

Immediately after the state machine starts to operate, it is considered that the intended object of detection is not present in the detection area of the radio wave sensor 1 and the sensor signal resulting from background signal is outputted from the radio wave sensor 1. Hence, the threshold value E2 set in the state NO is a value based on background noise.

As described above, in the state machine of FIG. 30, the parameter adjuster 14 sets the threshold value E2 for the threshold-based determination process according to an environment of ambient background noise in the activating period. In more detail, rather than performing the recognition process immediately after activation, the parameter adjuster 14 initially measures the level of the ambient background noise from the sensor signal and then calculates the threshold value E2 by multiplying the measured value by the predetermined coefficient. Therefore, the threshold value E2 can be changed appropriately in the activating period, and thereby it is possible to reduce the probability of the false detection caused by the background noise even when the ambient environment of the radio wave sensor 1 changes and also the level of the background noise changes.

Thereafter, the state machine changes from the state I00 to a state S11 (t02), and in the state S11, when a state (hereinafter referred to as “detection state”) in which the recognizer 7 has detected the intended object of detection occurs, the state machine further changes to a state W11 (t03). In contrast, in the state S11, when a state (hereinafter referred to as “non-detection state”) in which the recognizer 7 has not detected the intended object of detection occurs, the state machine changes to a state S16 after a lapse of a predetermined time period from time of changing to the state S11 (t04). Thereafter, at the state S16, when the non-detection state occurs, the state machine changes to the state S11 (t05). In short, when the non-detection state continues from the state S11, the state machine shows repeating transitions between the state S11 and the state S16.

When the detection state occurs in the state S11 or the state S16, the state machine changes to the state W11 (t03, t06). After waiting for a preliminarily determined time period at the state W11, the state machine changes to a state S12 (t07) and further changes to a state S13 unconditionally (t08). In the state S13, when the non-detection state occurs, or when the detection state continues for a predetermined time period or more, the state machine changes to a state S14 (t09). Thereafter, when the detection state occurs in the state S14, the state machine changes to the state S13 (t10). In short, when the detection state continues from the state S13, the state machine shows repeating transitions between the state S13 and the state S14.

When the non-detection state occurs in the state S14, the state machine changes to a state S15 (t11). When the non-detection state occurs in the state S15, the state machine changes to the state S11 (t12). When the detection state occurs in the state S15, the state machine changes to the state W11 (t13).

In summary, while the non-detection state occurs, the state machine changes around the state S11. While the detection state occurs, the state machine changes around the state S13. The signal processing device 2 performs the processes of the aforementioned steps X1 to X7 while the state machine changes between the states.

In the state machine shown in FIG. 30, when the detection state continues from the state S13, repeat transitions between the state S13 and the state S14 are shown. In view of this, when the repeat transitions between the state S13 and the state S14 occur, it is possible to measure continuous time of the detection state by counting the number of times of passing through the state S14. In consideration of this, an upper limit of the continuous time of the detection state or the number of times of passing through the state S14 is selected in advance. When the continuous time or the number of times of passing through the state S14 exceeds its upper limit at the state S14, even when the detection state continues, the state machine does not change to the state S13 but changes to the state I11 (t14).

When the threshold value E2 used in the threshold-based determination process is excessively small, such continuation of the detection state is likely to occur. Therefore, in the state I11, the parameter adjuster 14 performs operation of resetting the threshold value E2. In more detail, in the state I11, the A/D conversion process, the DCT process, and the filter bank process are conducted on the sensor signal (the steps X1 to X3 in FIG. 23), and thus intensities of signals of the individual filter banks 5a are measured. Thereafter, the parameter adjuster 14 calculates the threshold value E2 by multiplying the average of the intensities of the signals of all of or a plurality of filter banks 5a by a predetermined coefficient, and thus uses calculated threshold value E2 as the threshold value in the subsequent threshold-based determination process. Further, the available range of the threshold value E2 may be delimited by predetermined upper and lower limits.

Note that, only when the threshold value E2 newly calculated in the state I11 is larger than the threshold value E2 currently used, the parameter adjuster 14 replaces the threshold value E2 currently used with the threshold value E2 newly calculated in the state I11. In contrast, when the threshold value E2 newly calculated in the state I11 is not larger than the threshold value E2 currently used, the parameter adjuster 14 does not use the threshold value E2 newly calculated in the state I11 and thus continues to use the threshold value E2 currently used. After the process in the state I11 ends, the state machine changes to the state S11 (t15).

Further, in the state machine shown in FIG. 30, when the non-detection state continues from the state S11, repeat transitions between the state S11 and the state S16 are shown. In view of this, when the repeat transitions between the state S11 and the state S16 occur, it is possible to measure continuous time of the non-detection state by counting the number of times of passing through the state S16. In consideration of this, an upper limit of the continuous time of the detection state or the number of times of passing through the state S16 is selected in advance. When the continuous time or the number of times of passing through the state S16 exceeds its upper limit at the state S11, even when the non-detection state continues, the state machine does not change to the state S16 but changes to the state I12 (t16).

When the threshold value E2 used in the threshold-based determination process is excessively large, such continuation of the non-detection state is likely to occur. Therefore, in the state I12, the parameter adjuster 14 performs operation of resetting the threshold value E2. In more detail, in the state I12, the A/D conversion process, the DCT process, and the filter bank process are conducted on the sensor signal (the steps X1 to X3 in FIG. 23), and thus intensities of signals of the individual filter banks 5a are measured. Thereafter, the parameter adjuster 14 calculates the threshold value E2 by multiplying the average of the intensities of the signals of all of or a plurality of filter banks 5a by a predetermined coefficient, and thus uses the calculated threshold value E2 as the threshold value in the subsequent threshold-based determination process. Further, the available range of the threshold value E2 may be delimited by predetermined upper and lower limits.

Note that, only when the threshold value E2 newly calculated in the state I12 is smaller than the threshold value E2 currently used, the parameter adjuster 14 replaces the threshold value E2 currently used with the threshold value E2 newly calculated in the state I12. In contrast, when the threshold value E2 newly calculated in the state I12 is not smaller than the threshold value E2 currently used, the parameter adjuster 14 does not use the threshold value E2 newly calculated in the state I12 and thus continues to use the threshold value E2 currently used. After the process in the state I12 ends, the state machine changes to the state S11 when the non-detection state occurs (t17), and changes to the state W11 when the detection state occurs (t18).

As described above, when the detection state or non-detection state continues for a predetermined period or more, it is determined that the current threshold value E2 is set to an inappropriate value for current background or ambient noise, and therefore the reset of the threshold value E2 is performed. Therefore, when the false detection frequently occurs due to an excessively small value of the threshold value E2, the current threshold value E2 is replaced with a larger one, and thus probability of the false detection can be reduced. Further, the object of detection target cannot be detected due to an excessively large value of the threshold value E2, the current threshold value E2 is replaced with a smaller one, and thus detection sensitivity can be improved and probability of failure of detection can be reduced.

However, even when the threshold value E2 used in the threshold-based determination process is updated in the aforementioned manner, the false detection and miss detection may occur due to a large change in the circumstances. The miss detection means that though the intended object of detection is present, the non-detection state occurs.

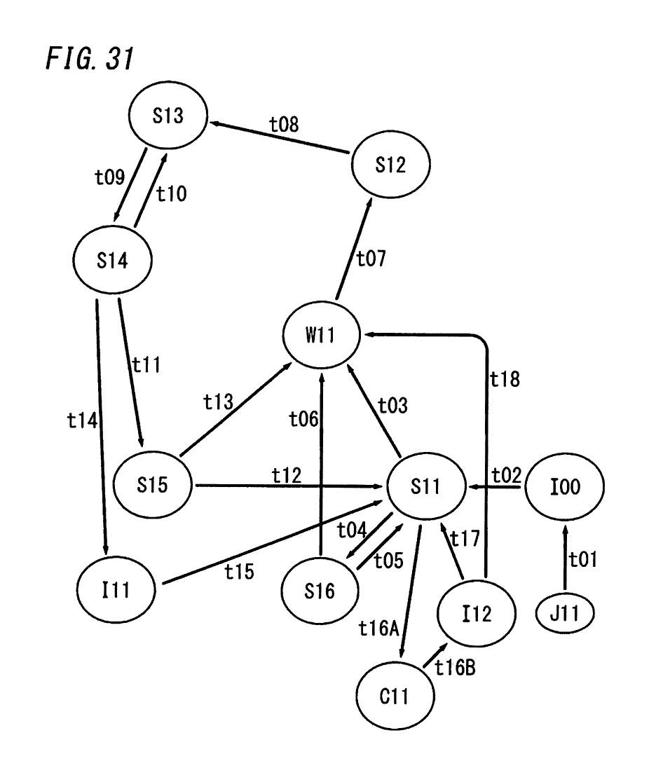

In view of this, the signal processing device 2 of the present embodiment includes the level setter 13 (see FIG. 1). FIG. 31 shows operation of the state machine using the level setter 13.

The level setter 13 is configured to set a sensitivity level indicative of a degree of detection sensitivity of the object for the recognition process performed by the recognizer 7. The level setter 13 is configured to, when determining that the recognizer 7 is likely to cause the false detection even when an update process of the threshold value E2 is performed in the state I11 or 112, set the sensitivity level to a low level. The level setter 13 is configured to, when determining that the recognizer 7 is not likely to cause the false detection, set the sensitivity level to a high level.

The parameter adjuster 14 is configured to set the parameter to increase the detection sensitivity of the object when the sensitivity level set by the level setter 13 is the high level, and is configured to set the parameter to decrease the detection sensitivity of the object when the sensitivity level set by the level setter is the low level. In more detail, when the sensitivity level set by the level setter 13 is the high level, a range (upper and lower limits) of the parameter adjusted by the parameter adjuster 14 is set so that the object is relatively easily detected. In contrast, when the sensitivity level set by the level setter 13 is the low level, the range (upper and lower limits) of the parameter adjusted by the parameter adjuster 14 is set so that the object is not relatively easily detected.

FIG. 31 shows an additional state C11 between the states S11 and the state I12 of the state machine of FIG. 30.

When the detection state occurs in any of the states S11, S15, S16, and 112, the state machine changes to the state W11 (t03, t06, t13, t18), and waits for predetermined time in the state W11 and then changes to the state S12 (t07).

In the state S12, the level setter 13 performs the update process of the sensitivity level. In more detail, the level setter 13 determines whether the detection state causing change to the state W11 occurs due to detection of the intended object of detection or the false detection caused by motion of object other than the intended object of detection (noise). The determination process of the level setter 13 is performed based on the recognition result of the recognizer 7 on the basis of the sensor signal at the current time. When determining that the detection state causing change to the state W11 occurs due to detection of the intended object of detection, the level setter 13 determines that a current situation is a situation where the recognizer 7 is not likely to cause the false detection (normal situation). When determining that the detection state causing change to the state W11 occurs due to the false detection caused by motion of object other than the intended object of detection (noise), the level setter 13 determines that the current situation is a situation where the recognizer 7 is likely to cause the false detection (noise existing situation).

The level setter 13 has a function of setting a flag indicative of the degree of the detection sensitivity of the intended object of detection for the recognition process of the recognizer 7, and updates the flag based on a result of the aforementioned determination process. When determining that the current situation is the normal situation, the level setter 13 sets the flag to “0”. When determining that the current situation is the noise existing situation, the level setter 13 sets the flag to “1”. The flag of “0” corresponds to the sensitivity level: “high”, and the flag of “1” corresponds to the sensitivity level: “low”.

Note that, it is preferable that the level setter 13 perform the update process of the flag when a number of consecutive times of determining that the current situation is the noise existing situation is equal to or more than a predetermined number of times, or when a number of consecutive times of determining that the current situation is the normal situation is equal to or more than a predetermined number of times. Alternatively, it is preferable that the level setter 13 perform the update process of the flag when a number of times of determining that the current situation is the noise existing situation is equal to or more than a predetermined number of times within a predetermined time period, or when a number of times of determining that the current situation is the normal situation is equal to or more than a predetermined number of times within a predetermined time period.

In summary, when determining that the recognizer 7 is likely to cause the false detection due to noise, the level setter 13 sets the sensitivity level to the low level. When determining that the recognizer 7 is not likely to cause the false detection, the level setter 13 sets the sensitivity level to the high level (the level setter 13 sets the sensitivity level to its default level). When the level setter 13 completes the setting process of the sensitivity level, the state machine changes from the state S12 to the state S13 (t08).

In subsequent processes, the parameter adjuster 14 refers to the state of the flag (0 or 1), and sets the threshold value E2 so as to increase the detection sensitivity when the flag is “0” (settings for the normal situation). When the flag is “1”, the parameter adjuster 14 sets the threshold value E2 so as to decrease the detection sensitivity of the object (settings for the noise existing situation). In other words, when the flag is “0”, the parameter adjuster 14 sets the adjustable range of the threshold value (E2) to a range of relatively low values. When the flag is “1”, the parameter adjuster 14 sets the adjustable range of the threshold value (E2) to a range of relatively high values.

When a continuous time period of the non-detection state exceeds its upper limit in the state S11, the state machine does not change to the state S16 but changes to state C11 (t16A) even when the non-detection state occurs. Also in the state C11, the level setter 13 updates the settings of the flag. In more detail, the level setter 13 determines whether the non-detection state causing change to the state C11 occurs due to actual absence of the intended object of detection or mistake of determining that the intended object of detection is absent under a condition where the intended object of detection is actually present. The determination process of the level setter 13 is performed based on the recognition result of the recognizer 7 on the basis of the sensor signal at the current time. When determining that the non-detection state causing change to the state C11 occurs due to actual absence of the intended object of detection, the level setter 13 determines that the current situation is a situation where the recognizer 7 is not likely to cause the false detection (normal situation). When determining that the non-detection state causing change to the state C11 occurs due to mistake of determining that the intended object of detection is absent under a condition where the intended object of detection is actually present, the level setter 13 determines that the current situation is a situation where the recognizer 7 is likely to cause the false detection (noise existing situation).

Then, the level setter 13 updates the settings of the flag based on the result of the aforementioned determination process. The level setter 13 sets the flag to “0” when determining that the current situation is the normal situation, and sets the flag to “1” when determining that the current situation is the noise existing situation. When the level setter 13 completes the setting process of the sensitivity level, the state machine changes from the state C11 to the state 112 (t16B).

Note that, it is preferable that the level setter 13 perform the update process of the flag when a number of consecutive times of determining that the current situation is the noise existing situation is equal to or more than a predetermined number of times, or when a number of consecutive times of determining that the current situation is the normal situation is equal to or more than a predetermined number of times. Alternatively, it is preferable that the level setter 13 perform the update process of the flag when a number of times of determining that the current situation is the noise existing situation is equal to or more than a predetermined number of times within a predetermined time period, or when a number of times of determining that the current situation is the normal situation is equal to or more than a predetermined number of times within a predetermined time period.

In subsequent processes, the parameter adjuster 14 refers to the state of the flag (0 or 1), and sets the threshold value E2 so as to increase the detection sensitivity when the flag is “0”. When the flag is “1”, the parameter adjuster 14 sets the threshold value E2 so as to decrease the detection sensitivity of the object. In other words, when the flag is “0”, the parameter adjuster 14 sets the adjustable range of the threshold value E2 to a range of relatively low values. When the flag is “1”, the parameter adjuster 14 sets the adjustable range of the threshold value E2 to a range of relatively high values.

Note that, the level setter 13 may perform the determination process of the noise existing situation and the normal situation in a manner such as a manner based on pattern recognition using a distribution of a frequency component of a sensor signal, and a manner of determining presence or absence of features not considered as the intended object of detection based on a previous variation of a sensor signal.

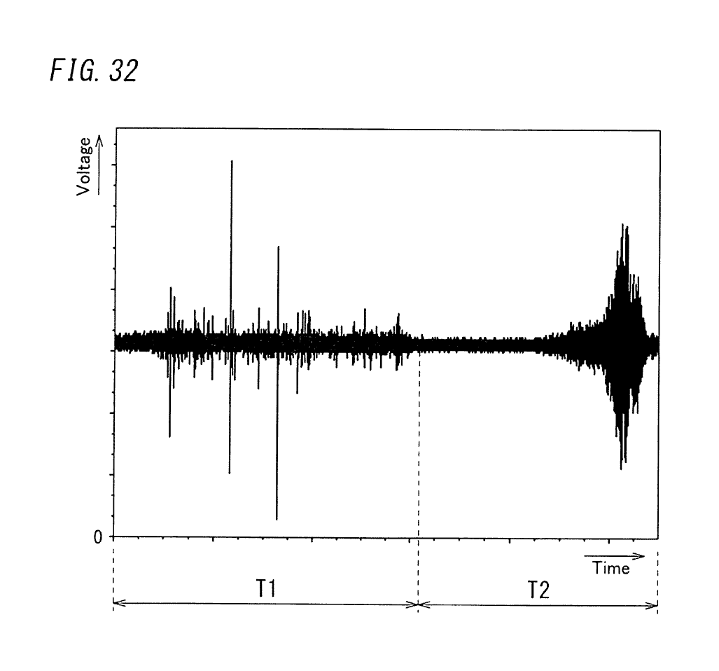

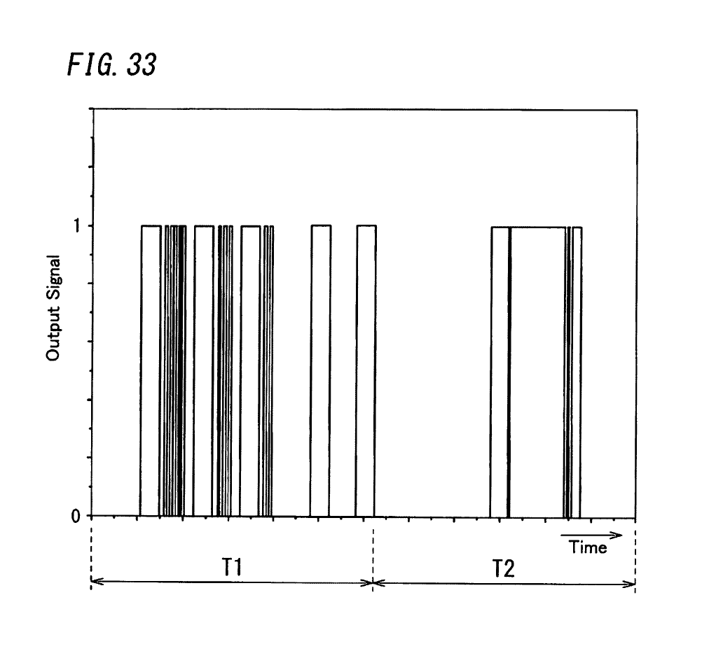

FIG. 32 and FIG. 33 show results of simulation based on the basic operation of the state machine shown in FIG. 30 (operation without using the level setter 13). FIG. 32 shows one example of the sensor signal outputted from the radio wave sensor 1. FIG. 33 shows the output signal of the outputter 12. When the recognizer 7 has detected the intended object of detection, the output signal has a high level (corresponding to “1” in this instance). When the recognizer 7 has not detected the intended object of detection, the output signal has a low level (corresponding to “0” in this instance). With regard to the sensor signal of FIG. 32, the sensor signal under the noise existing situation occurs in a time period T1, and the sensor signal resulting from the approaching intended object of detection occurs in a time period T2. In this case, the output signal of the outputter 12 shows that the false detection in terms of detection of the intended object of detection frequently occurs in the time period T1. In summary, in the basic operation of the state machine shown in FIG. 30, the false detection resulting from noise may occur frequently.

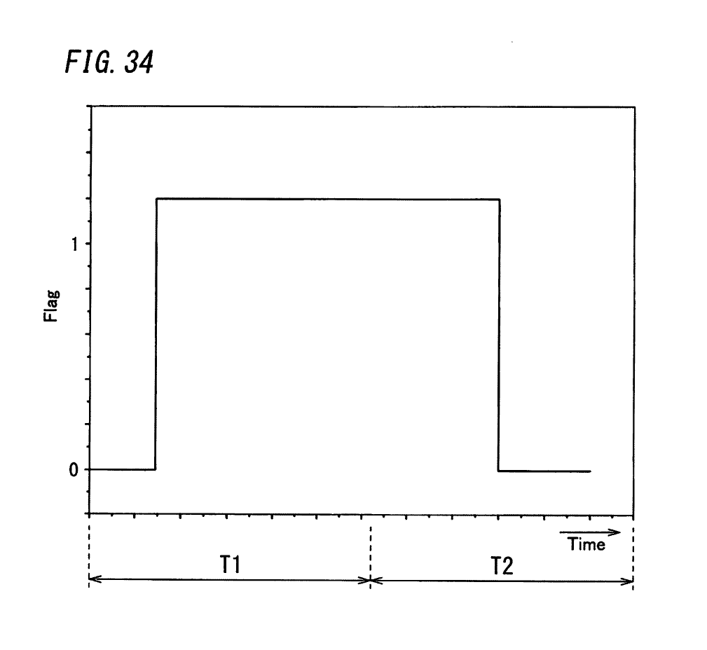

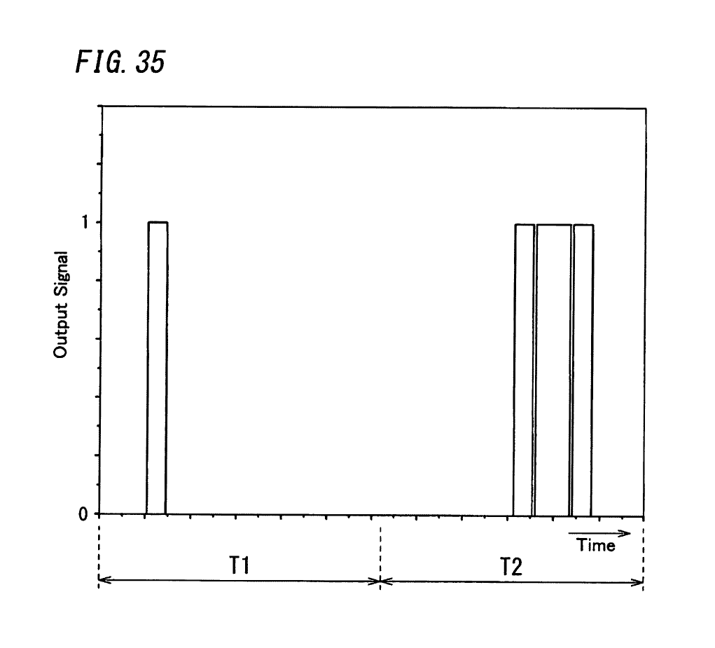

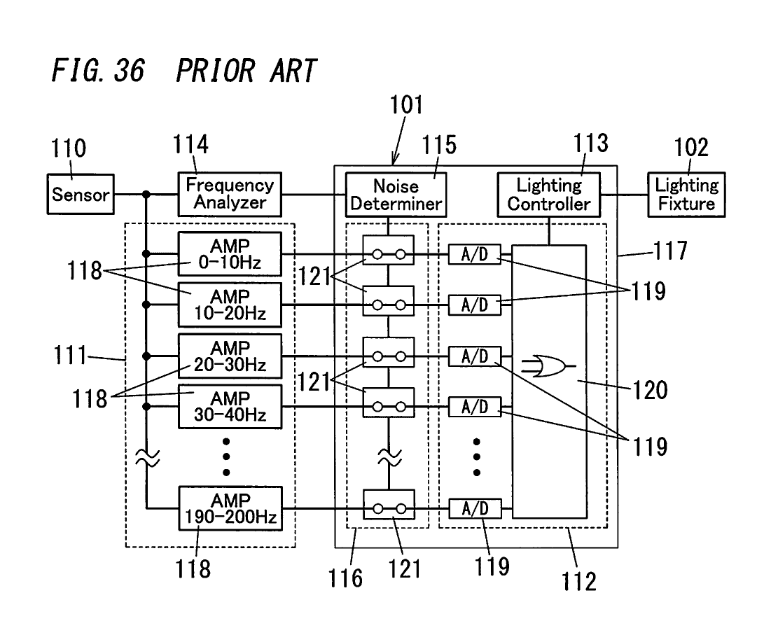

Next, FIG. 34 and FIG. 35 show results of simulation based on the operation of the state machine shown in FIG. 31 (operation using the level setter 13). FIG. 34 shows the state of the flag set by the level setter 13. FIG. 35 shows the output signal of the outputter 12 resulting from the sensor signal of FIG. 32.

The output signal of the outputter 12 indicates the detection state at beginning of the time period T1. In this case, the level setter 13 determines that the false detection caused by noise has occurred, and then changes the flag from “0” to “1” in the state S12. When the flag is changed from “0” to “1”, the parameter adjuster 14 sets the threshold (E2) in conformity with the settings for the noise existing situation, and thus the output signal of the outputter 12 indicates the non-detection state. In more detail, when the flag is changed from “0” to “1”, the parameter adjuster 14 sets the threshold value E2 to decrease the detection sensitivity, and therefore the probability of the false detection caused by noise can be reduced in the subsequent process.

After the non-detection state continues, the level setter 13 changes the flag from “1” to “0” at the state C11, and thereby the parameter adjuster 14 sets the threshold value E2 in conformity with settings for the normal situation.

As described above, in the state machine shown in FIG. 31, the parameter adjuster 14 switches between settings of the threshold value E2 for the normal situation and settings of the threshold value E2 for the noise existing situation. The settings of the threshold value E2 for the noise existing situation can more suppress the probability of the false detection than the settings of the threshold value E2 for the normal situation.

In the state machine shown in FIG. 31, the flag set by the level setter 13 can be updated in the state S12 and the state C11. However, while the recognizer 7 performs the recognition process, the level setter 13 may switch the state of the flag and thus the parameter adjuster 14 may change the threshold value E2. This may lead to improper operation. Therefore, the signal processing device 2 does not allow the recognizer 7 to perform the recognition process of the intended object of detection in the state S12 and the state C11. In other words, the level setter 13 is configured to change the state of the flag (the sensitivity level) while the recognizer 7 does not perform the recognition process, and is configured not to change the state of the flag (the sensitivity level) while the recognizer 7 performs the recognition process. Processes of the state machine are separate from each other, and thus the recognition process of the intended object of detection and the update process of the threshold value E2 are performed at different timings. Accordingly, it is possible to suppress occurrence of improper operation while the recognizer 7 performs the recognition process.

Additionally, the update process of the state of the flag in the state S12 and the state C11 is performed based on only the sensor signal inputted during time periods of the state S12 and the state C11. However, when the update process of the state of the flag in the state S12 and the state C11 is performed based on only the sensor signal inputted during a time period the state machines stays in the state S12 or the state C11, it may be impossible to determine whether the current situation is the normal situation or the noise existing situation. In view of this, the level setter 13 may perform the update process of the state of the flag based on the sensor signal inputted during a time period longer than the time periods of the state S12 and the state C11 and/or a history of the recognition process based on this sensor signal, for example.

In more detail, in addition to the state machine of FIG. 31, the signal processing device 2 includes the level setter 13 provided with a monitoring unit for monitoring contents of the sensor signal and the recognition process using this sensor signal, irrespective of the state of the state machine. This monitoring unit continues to monitor an object to be monitored, without causing any effect on the recognition process performed by the recognizer 7. When the state machine of FIG. 31 changes to the state C11 or the state S12, the signal processing device 2 performs the update process of the state of the flag with reference to information stored in the monitoring unit. In other words, it is preferable that the level setter 13 be configured to collect information for determining whether the recognizer 7 is likely to cause the false detection, irrespective of operations of the parameter adjuster 14 and the recognizer 7.

In the state machine of FIG. 31, the level setter 13 sets the sensitivity level depending on a situation of occurrence of the false detection caused by the recognizer 7, thereby adjusting improvement of the detection sensitivity and reduction of the false detection. Further, the signal processing device 2 changes the sensitivity level according to the state of the sensor signal to thereby set the parameter according to the sensitivity level while it is in operation. Therefore, even when the circumstances vary, the signal processing device 2 can balance the improvement of the detection sensitivity with the reduction of the probability of the false detection.

The signal processing device 2 may set a parameter which is different from the parameter used for the normal situation and is capable of suppressing the false detection in the noise existing situation. However, use of the parameter capable of suppressing the false detection in the noise existing situation may lead to a decrease in the detection sensitivity. In view of this, normally, the operation is conducted by use of the parameter for the normal situation which puts priority on the detection sensitivity. When it is determined that noise occurs, the parameter for the noise existing situation which puts priority on the reduction of the probability of the false detection is selected, and thereby the false detection can be suppressed. When it is determined that the probability of the false detection caused by noise is reduced, the parameter for the normal situation is selected and therefore the detection sensitivity can be returned to a normal state.

Therefore, the signal processing device 2 is capable of reducing a probability of false detection caused by motion of an object other than an intended object of detection while balancing improvement of the detection sensitivity with reduction of the probability of the false detection.

Note that, the parameter to be changed by the parameter adjuster 14 may not be limited to the threshold values E1 and E2 used for the aforementioned threshold-based determination process.

For example, when the recognizer 7 performs the recognition process based on multiple linear regression analysis, signal components A2 and A3 are isolated by the multiple linear regression analysis from data A1 on the normalized intensity outputted from the normalizer 6 on the time axis (see FIG. 19A). The signal component A2 is derived from movement of a person, and the signal component A3 is derived from noise. The signal processing device 2 is configured to, only when an amount of change per unit time in the signal component A2 which is extracted by the particular filter bank 5a and relates to an object to be detected is smaller than a threshold value E11, allow the recognizer 7 to perform the recognition process, or treat the result of the recognition process performed by the recognizer 7 as being valid. The signal processing device 2 sets the threshold value E11 and therefore can avoid outputting the determination result considered as the false detection caused by noise.

In this case, the parameter adjuster 14 refers to the state of the flag (0 or 1), and sets the threshold value E11 so as to increase the detection sensitivity when the flag is “0”. When the flag is “1”, the parameter adjuster 14 sets the threshold value E11 so as to decrease the detection sensitivity of the object. In other words, when the flag is “0”, the parameter adjuster 14 sets the adjustable range of the threshold value E11 to a range of relatively high values. When the flag is “1”, the parameter adjuster 14 sets the adjustable range of the threshold value E11 to a range of relatively low values. In other words, the parameter adjuster 14 selects the threshold value E11 as a parameter to be set.

Alternatively, the signal processing device 2 may be configured to, only when an amount of change per unit time in an intensity of a signal passing through a particular filter bank 5a (signal before normalization) is smaller than a threshold value E21, allow the recognizer 7 to perform the recognition process, or treat the result of the recognition process performed by the recognizer 7 as being valid. The signal processing device 2 sets the threshold value E21 and therefore can avoid outputting the determination result considered as the false detection caused by noise.

In this case, the parameter adjuster 14 refers to the state of the flag (0 or 1), and sets the threshold value E21 so as to increase the detection sensitivity when the flag is “0”. When the flag is “1”, the parameter adjuster 14 sets the threshold value E21 so as to decrease the detection sensitivity of the object. In other words, when the flag is “0”, the parameter adjuster 14 sets the adjustable range of the threshold value E21 to a range of relatively high values. When the flag is “1”, the parameter adjuster 14 sets the adjustable range of the threshold value E21 to a range of relatively low values. In other words, the parameter adjuster 14 selects the threshold value E21 as a parameter to be set.

Note that, the parameter adjuster 14 may set only one parameter or may set a set of multiple parameters.

Further, the recognizer 7 may have a function of detecting the object by performing the recognition process by a neural network instead of the aforementioned recognition process. In this case, in the signal processing device 2, the detection accuracy by the recognizer 7 can be improved.

### SUMMARY

The aforementioned signal processing device 2 includes the frequency analyzer 5, the recognizer 7, the level setter 13, and the parameter adjuster 14. The frequency analyzer 5 is configured to convert the sensor signal which is outputted from the radio wave sensor 1 (sensor) for receiving the wireless signal reflected by the object and depends on motion of the object, into the frequency domain signal, and extract, by use of the group of individual filter banks 5a with different frequency bands, signals of the individual filter banks 5a from the frequency domain signal. The recognizer 7 is configured to perform the recognition process of detecting the object based on at least one of the frequency distribution based on the signals of the individual filter banks 5a and the component ratio of signal intensities based on the signals of the individual filter banks 5a. The level setter 13 is configured to set a sensitivity level indicative of the degree of the detection sensitivity of the object for the recognition process. The parameter adjuster 14 is configured to change the parameter for adjusting the detection sensitivity of the object for the recognition process. The parameter adjuster 14 is configured to set the parameter to increase the detection sensitivity of the object when the sensitivity level set by the level setter 13 is a high level, and being configured to set the parameter to decrease the detection sensitivity of the object when the sensitivity level set by the level setter 13 is a low level.

According to this configuration, the signal processing device 2 controls the level setter 13 to set the sensitivity level depending on the situation of occurrence of the false detection caused by the recognizer 7, thereby adjusting improvement of the detection sensitivity and the reduction of the probability of the false detection. Further, the signal processing device 2 selects the sensitivity level according to the state of the sensor signal so as to set the parameter according to the sensitivity level, and thereby can balance the improvement of the detection sensitivity with the reduction of the probability of the false detection even when the circumstances vary. Consequently, the signal processing device 2 can offer effects of reducing the probability of the false detection caused by motion of an object other than the intended object of detection while balancing improvement of the detection sensitivity with reduction of the probability of the false detection.

In a preferable configuration, the level setter 13 may be configured to set the sensitivity level to the low level when determining that the recognizer 7 is likely to cause false detection, and is configured to set the sensitivity level to the high level when determining that the recognizer 7 is not likely to cause the false detection.

According to this configuration, the signal processing device 2 can set the sensitivity level depending on the situation of occurrence of the false detection.

In a preferable configuration, the level setter 13 may be configured to collect information for determining whether the recognizer 7 is likely to cause the false detection, irrespective of operations of the parameter adjuster 14 and the recognizer 7.

According to this configuration, the signal processing device 2 can determine whether the false detection is likely to occur, irrespective of operations of the parameter adjuster 14 and the recognizer 7.

In a preferable configuration, the level setter 13 may be configured to change the sensitivity level while the recognizer 7 does not perform the recognition process, and is configured not to change the sensitivity level while the recognizer 7 performs the recognition process.

According to this configuration, the signal processing device 2 can suppress improper operation while the recognizer 7 performs the recognition process.

In a preferable configuration, the recognizer 7 may be configured to, when a sum of intensities of the signals of the individual filter banks 5a is equal to or larger than a first threshold value, perform the recognition process or treat a result of the recognition process as being valid. The parameter adjuster 14 may be configured to change the first threshold value serving as the parameter.

According to this configuration, the signal processing device 2 can improve the detection accuracy with the recognizer 7.

In a preferable configuration, the recognizer 7 may be configured to extract a signal component resulting from motion of the object from each of intensities of the signals of the individual filter banks 5a. The recognizer 7 may be configured to, when an amount of change per unit time in an extracted signal component of at least one of the individual filter banks 5a is smaller than a second threshold value, perform the recognition process or treat a result of the recognition process as being valid. The parameter adjuster 14 may be configured to change the second threshold value serving as the parameter.

According to this configuration, the signal processing device 2 can improve the detection accuracy with the recognizer 7.

In a preferable configuration, the recognizer 7 may be configured to, when an amount of change per unit time in the intensity of the signal of at least one of the individual filter banks 5a is smaller than a third threshold value, perform the recognition process or treat a result of the recognition process as being valid. The parameter adjuster 14 may be configured to change the third threshold value serving as the parameter.

According to this configuration, the signal processing device 2 can improve the detection accuracy at the recognizer 7.

In a preferable configuration, the signal processing device 2 may include the normalizer 6. The normalizer 6 may be configured to normalize intensities of the signals individually passing through the individual filter banks 5a by a sum of the signals extracted by the frequency analyzer 5 or a sum of intensities of signals individually passing through predetermined filter banks 5a selected from the individual filter banks 5a to obtain normalized intensities, and output the normalized intensities. The recognizer 7 may be configured to perform the recognition process of detecting the object based on at least one of a frequency distribution and a component ratio of the normalized intensities which are calculated from the normalized intensities of the individual filter banks 5a outputted from the normalizer 6.

According to this configuration, the signal processing device 2 can reduce the probability of the false detection caused by motion of an object other than the intended object of detection.

1. A signal processing device comprising:
a frequency analyzer configured to convert a sensor signal which is outputted from a sensor for receiving a wireless signal reflected by an object and depends on motion of the object, into a frequency domain signal, and extract, by use of a group of individual filter banks with different frequency bands, signals of the individual filter banks from the frequency domain signal;
a recognizer configured to perform a recognition process of detecting the object based on at least one of a frequency distribution based on the signals of the individual filter banks and a component ratio of signal intensities based on the signals of the individual filter banks;
a level setter configured to set a sensitivity level indicative of a degree of detection sensitivity of the object for the recognition process;
a parameter adjuster configured to change a parameter for adjusting the detection sensitivity of the object for the recognition process,
the parameter adjuster being configured to set the parameter to increase the detection sensitivity of the object when the sensitivity level set by the level setter is a high level, and being configured to set the parameter to decrease the detection sensitivity of the object when the sensitivity level set by the level setter is a low level.

2. The signal processing device of claim 1, wherein
the level setter is configured to set the sensitivity level to the low level when determining that the recognizer is likely to cause false detection, and is configured to set the sensitivity level to the high level when determining that the recognizer is not likely to cause the false detection.

3. The signal processing device of claim 2, wherein
the level setter is configured to collect information for determining whether the recognizer is likely to cause the false detection, irrespective of operations of the parameter adjuster and the recognizer.

4. The signal processing device of claim 1, wherein
the level setter is configured to change the sensitivity level while the recognizer does not perform the recognition process, and is configured not to change the sensitivity level while the recognizer performs the recognition process.

5. The signal processing device of claim 1, wherein:
the recognizer is configured to, when a sum of intensities of the signals of the individual filter banks is equal to or larger than a first threshold value, perform the recognition process or treat a result of the recognition process as being valid; and
the parameter adjuster is configured to change the first threshold value serving as the parameter.

6. The signal processing device of claim 1, wherein:
the recognizer is configured to extract a signal component resulting from motion of the object from each of intensities of the signals of the individual filter banks, and is configured to, when an amount of change per unit time in an extracted signal component of at least one of the individual filter banks is smaller than a second threshold value, perform the recognition process or treat a result of the recognition process as being valid; and
the parameter adjuster is configured to change the second threshold value serving as the parameter.

7. The signal processing device of claim 1, wherein:
the recognizer is configured to, when an amount of change per unit time in the intensity of the signal of at least one of the individual filter banks is smaller than a third threshold value, perform the recognition process or treat a result of the recognition process as being valid; and
the parameter adjuster is configured to change the third threshold value serving as the parameter.

8. The signal processing device of claim 1, further comprising a normalizer configured to normalize intensities of the signals individually passing through the individual filter banks by a sum of the signals extracted by the frequency analyzer or a sum of intensities of signals individually passing through predetermined filter banks selected from the individual filter banks to obtain normalized intensities, and output the normalized intensities,
the recognizer being configured to perform the recognition process of detecting the object based on at least one of a frequency distribution and a component ratio of the normalized intensities which are calculated from the normalized intensities of the individual filter banks outputted from the normalizer.
